(19) United States
(12) Patent Application Publication
(10) Pub. No.: US 2011/0157470 A1
(43) Pub. Date: Jun. 30, 2011

(54) RECEIVER, RECEIVING METHOD AND OUTPUT CONTROL METHOD

(76) Inventors: Sadao TSURUGA, Yokohama (JP); Hiroo Okamoto, Yokohama (JP)

(21) Appl. No.: 12/914,452

(22) Filed: Oct. 28, 2010

(30) Foreign Application Priority Data
Dec. 28, 2009 (JP) 2009-296691
Dec. 28, 2009 (JP) 2009-296693

(51) Int. Cl. H04N 3/27

(52) U.S. Cl. 348/554; 348/E03.049

(57) ABSTRACT

It is configured to receive digital content and output control information for controlling output of the relevant digital content, and when the output control information received shows that picture subjected to high resolution transformation using super-resolution technology is not allowed to be digitally outputted, to output the digital content to a display means in resolution equal to or lower than resolution of picture received.

### INCORPORATION BY REFERENCE

The present application claims priorities from Japanese applications JP2009-296691 filed on Dec. 28, 2009, JP2009-296693 filed on Dec. 28, 2009, the contents of which are hereby incorporated by reference into this application.

### BACKGROUND OF THE INVENTION

Technical field of the present invention relates to copy control of content.

Relating to the above technical field, in JP-A-2002-319227, there is described; PROBLEM TO BE SOLVED: To improve usability, when information ('copy one generation') which is allowed to have only its one generation copied is recorded by being rewritten into information ('copy no more') which inhibits further copying. SOLUTION: Only one generation is set so as to be copied ('copy one generation') within a specified time after recording to compensate for the case, where the recording is interrupted for some nonconforming. Furthermore, two identical streams are recorded on a medium, and one is used for ordinary viewing and the other is moved and saved on another medium, as necessary.

In addition, in JP-A-8-336046, there is described; PURPOSE: To restore high frequency components of original signal higher than a Nyquist frequency from the plural sets of digital data whose sampling positions are different and to provide high resolution data with less blurs. CONSTITUTION: The three sets of the digital data for which the same object is sampled while shifting positions are inputted 1. First data are inputted to a reference data butter 2, a position difference estimation part 3 obtains position difference (Δ1 and 2) between the first data and the succeeding data and a weighted calculation part 4 obtains weight corresponding to the position difference. In a wide band LPF and high resolution making part 6, input data are LPF processed, then sampled with an interval narrower than the sampling interval of input signals and stored in an intermediate buffer 7. A product sum part 8 weights the data of the intermediate buffer 7 and adds them together.

Still more, in JP-A-2007-282089, there is described PROBLEM TO BE SOLVED: To obtain audio preferable for auditory sensation by complementing multiple sound components missed by audio compression by adding an integer-degree harmonic of a different amplification factor in accordance with the amplitude of a digital audio signal. SOLUTION: An audio signal processing apparatus according to the present invention is characterized in comprising an adaptive multiplier 114 for non-linearly amplifying a digital audio signal based on a non-linear function, a first constant adder 116 for adding a first constant to an output signal of the adaptive multiplier, a signal multiplier 120 for multiplying an output signal of the first constant adder and the digital audio signal, and a gain multiplier 122 for controlling the gain of an output signal of the signal multiplier.

### SUMMARY OF THE INVENTION

In recent years, with service expansion of digital broadcasting, a recording device which is recordable digital broadcasting has been prevailing.

In recording digital broadcasting, digital broadcasting received is recorded in built-in OD (hard disk drive) in a recording device, and in the case where program of digital broadcasting is allowed (Copy Free) to copy from HDD to other recording medium (for example, an optical disk, a semiconductor memory, and other HDD), it is copied, and in the case where programs of digital broadcasting allow recording of one generation (Copy One Generation means that copy of copy (copy of two or more generation) is not approved), it is moved (transferred).

A recording device of JP-A-2002-319227 becomes possible to complement for the case of recording interruption, because of capable of copying as long as it is within a specified period, even in the case where the programs of the above digital broadcasting is “Copy One Generation”.

However, in a recording device of JP-A-2002-319227, it is not allowed to copy in the same way as in a conventional way, when specified time has been elapsed. For example, in a recording device which is not capable of recording programs to HDD and copying from HDD to an optical disk at the same time, it is considered the case that the specified time has been elapsed before completing copy from it HDD to the optical disk, when there are many programs to be recorded and access to HDD is crowded.

In addition, in recent years, such service has been available that after accumulating download content of encrypted movies or dramas etc. from an exterior server etc. via Internet to a built-in recording medium in a receiving apparatus, it is viewed (reproduced). However, the download content, in particular, content, in which export to a medium (meaning to copy content to an exterior device with copyright protected, an exterior apparatus connected by a network with copyright protected, and meaning copying function of content, in particular, based on utilization condition) is not allowed, cannot be viewed (regenerated) with other equipments, although can be viewed (regenerated) with only a receiving apparatus received.

Further, in recent years, in program content of digital broadcasting and the like, resolution of moving picture is limited in view of performance of a camera, limitation of transmission band region width, and contract condition with a copyright owner or the like. However, viewers have desire to view picture with higher quality. Therefore, technology for viewing finely by transforming picture with resolution limited to higher resolution, what is called super-resolution technology has been closely watched.

There are several methods for this super-resolution technology, and for example, in a signal processing device of JP-A-8-336046, there is described a technology for performing super-resolution by cancelling aliasing distortion in sampling to restore high frequency components of original signal. By use of the technology for performing this super-resolution, TV broadcasting becomes possible to view in higher picture quality.

In addition, in many of the program content of digital broadcasting or the like, compressed audio is used, and in many cases, high region components are lost in compressing audio. In an audio signal processing device of JP-A-2007-282089, there is described a high region complementing technology for complementing overtone components missed by audio compression to make possible to obtain audio preferable for auditory sensation, by adding integer-degree harmonic with a different amplification factor in accordance with amplitude of the digital audio signals to the original digital audio signals.

Further, by re-encoding processing of program content of digital broadcasting etc. after subjected to the super-resolution technology or high region complementing technology, it becomes possible to record the content improved to higher picture quality and higher audio quality than picture quality and audio quality of the original content, onto a HDD, an optical disk, a semiconductor memory, and other media.

However, when viewers use this super-resolution technology or high region complementing technology, it becomes possible to view the content in higher resolution or wider sound region components than resolution or sound region components of the original content, that is, those intended by a content creator or a copyright owner side. In many cases, this is preferable in view of benefit of viewers because of capable of viewing content in higher picture quality or higher audio quality, however, there may be a case generating disadvantage for a content creator side or a photographic subject. For example, there may be a case that limitation is present in resolution or audio quality in license agreement between a content provider or a copyright owner, and a broadcasting station. In this way, depending on content, there may be the cases leading to not preferable results by performing super-resolution processing or high region complementing technology.

In order to solve the above problem, one embodiment of the present invention is configured, for example, so as to receive digital content and output control information for controlling output of the relevant digital content, and when the output control information received shows that picture subjected to high resolution transformation using super-resolution technology is not allowed to be digitally outputted, so as to output the digital content to a display means in resolution equal to or lower than resolution of picture received.

According to the above means, in displaying, recording and outputting programs of digital broadcasting, while performing display control and copy control in taking consideration of intention of content providers or copyright owners, enhancement of usability for content recorded can be attained.

Other objects, features and advantages of the invention will become apparent from the following description of the embodiments of the invention taken in conjunction with the accompanying drawings.

### BRIEF DESCRIPTION OF THE DRAWINGS

FIG. 1 is a block chart showing a system configuration example.

FIG. 2 is a block chart showing a configuration example of a transmitter 1.

FIG. 3 is an example of a structure of a content use descriptor which is one of copy control information.

FIG. 4 is a description example of a content use descriptor to each field.

FIG. 5 is an example of a structure of a digital copy control descriptor which is one of copy control information.

FIG. 6 is an example of information for controlling copy generation.

FIG. 7 is an example of receiving processing in a receiver 3 of each field of a content use descriptor transmitted from a transmitter 1.

FIG. 8 is an operation example of program content protection by utilizing copy control information by a transmitter 1.

FIG. 9 is a control example in accumulating (recording) program content by utilizing copy control information by a receiver 3.

FIG. 10 is a block chart showing a configuration example of a receiver 3.

FIG. 11 is a drawing showing an example of a transport packet added with a time stamp.

FIG. 12 is a drawing showing an example recorded the program content to a recording medium.

FIG. 13 is a flow chart showing an example of creation procedure of copy information and copy number of management information in recording program content to allow recording of one generation.

FIG. 14 is a flow chart showing an example of copying procedure of program content.

FIG. 15 is a flow chart showing an example of moving (transferring) procedure of program content.

FIG. 16 is a drawing showing an example of a recording medium which is capable of managing multiple numbers of copies.

FIG. 17 is a flow chart showing an example of creation procedure of copy information and copy number of management information in recording program content to allow recording of one generation.

FIG. 18 is a drawing showing a limitation example of copy number.

FIG. 19 is a drawing showing one example of a typical sink of content accumulated in “Number Limited Copy Allowed” and copy control thereof.

FIG. 20 is a drawing showing one example of copy control information of content data in DTCP.

FIG. 21 is a drawing showing one example of copy control information of content data in DTCP.

FIG. 22 is a description example of a content use descriptor to each field.

FIG. 23 is a drawing showing one example of copy control information of content data in DTCP.

### DETAILED DESCRIPTION OF THE INVENTION

Explanation will be given below on examples (Examples) of suitable embodiments of the present invention. However, the present invention should not be limited to the present Examples. The present Examples relate to handling principally of information with “One Generation Copy Allowed”.

### <System>

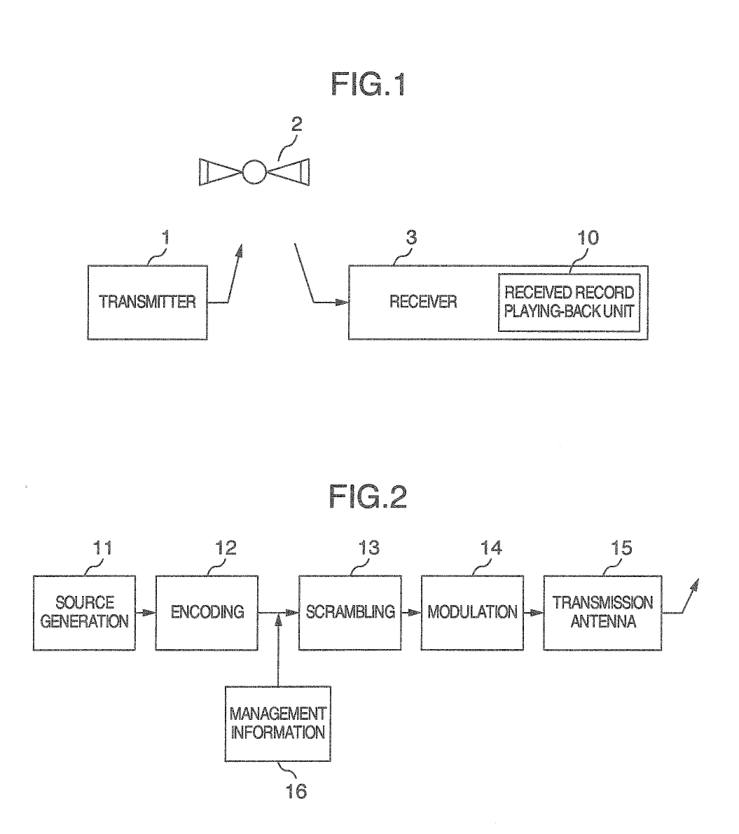

FIG. 1 is a block chart showing a configuration example of a system of the present Example. It exemplifies the case of transmitting and receiving information by broadcasting and recording and playing-back.

1 is a transmitter installed at information providing station such as a broadcasting station, 2 is a relay device installed at a relay station or a broadcasting satellite or the like, 3 installed at premises of a user is a receiver, and 10 is a built-in received record playing-back unit in the receiver 3. In the received record playing-back unit 10, information broadcasted can be recorded and reproduced.

The transmitter 1 transmits modulated signal wave via the relay device 2. As shown in FIG. 1, other than transmission by a satellite, for example, transmission by a cable, transmission by a telephone line, transmission by terrestrial broadcasting, and transmission utilizing IP (Internet Protocol) via a network such as Internet, or the like can be used. This signal wave received by the receiver 3, as will be described later, is recorded with converted to signals suitable for recording, as needed, after demodulation to information signals. In addition, a user can view the video and audio shown by the information signals, when a display is built-in in the receiver 3, with this display, and when it is not built-in, by connecting the receiver 3 and a display not shown.

### <Transmitter>

FIG. 2 is a block chart showing a configuration example of the transmitter 1 in the system of FIG. 1.

11 is a source generation unit, 12 is an encoding unit performing processing in an MPEG or H.264 system or the like, 13 is a scrambling unit, 14 is a modulation unit, 15 is a transmission antenna, and 16 is management information giving unit. Information of video and audio or the like generated in the source generation unit 11 composed of a camera and a recording and playing-back device or the like, is compressed as for data amount at the encoding unit 12, so as to be able to transmit in smaller occupation band region. At the scrambling unit 13, it is encrypted for transmission, as needed, so as to be viewed by a specified viewer. It is modulated at the modulation unit 14 so as to become signals suitable for transmission of OFDM, TC8PSK, and QPSK or the like, and thereafter transmitted as radio wave toward the relay device 2 from the transmission antenna 15. In this time, in the management information giving unit 16, copy control information or information of present time or the like is added, which is information for controlling copy.

It should be noted that, in many cases, multiple information are multiplexed in one radio wave by a method such as time sharing, spread spectrum. Although not shown in FIG. 2 for simplicity, in this case, systems of the source generation unit 11 and the encoding unit 12 are present in multiple, and between the encoding unit 12 and the scrambling unit 13, a multiplexing unit (a multiplexing unit) for multiplexing multiple information is placed.

### <Copy Control Information>

Copy control information is information for controlling copy allowance or not, or limitation of copy number or the like, and added, for example, at the management information giving unit 16. It includes the content use descriptor and a digital copy control descriptor or the like.

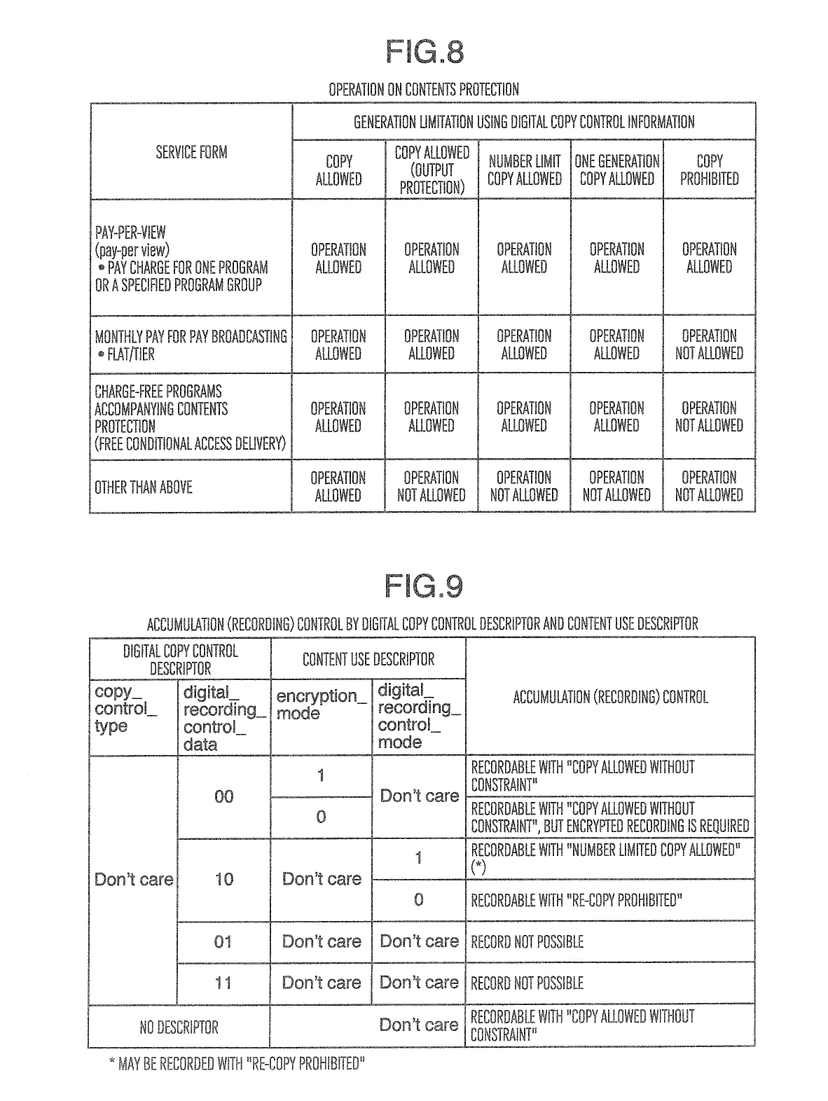

FIG. 8 shows an operation example relating to program content protection by utilizing copy control information.

“Operation allowed” indicates that a transmission side can select it as generation limitation using digital copy control information, for content corresponding to each service form. For example, “pay-per-view” indicates that any digital copy control information may be used, on the other hand “pay broadcasting by the month or the like” indicates that a transmission side cannot select “copy prohibited”.

As for “flat/tier”, contract of a plurality of channels all inclusive such as pay-broadcasting is called a flat contract, while contract by each channel is called a tier contract.

“Other than the above” includes, for example, “a case of not pay-broadcasting and a program not accompanying with content protection”.

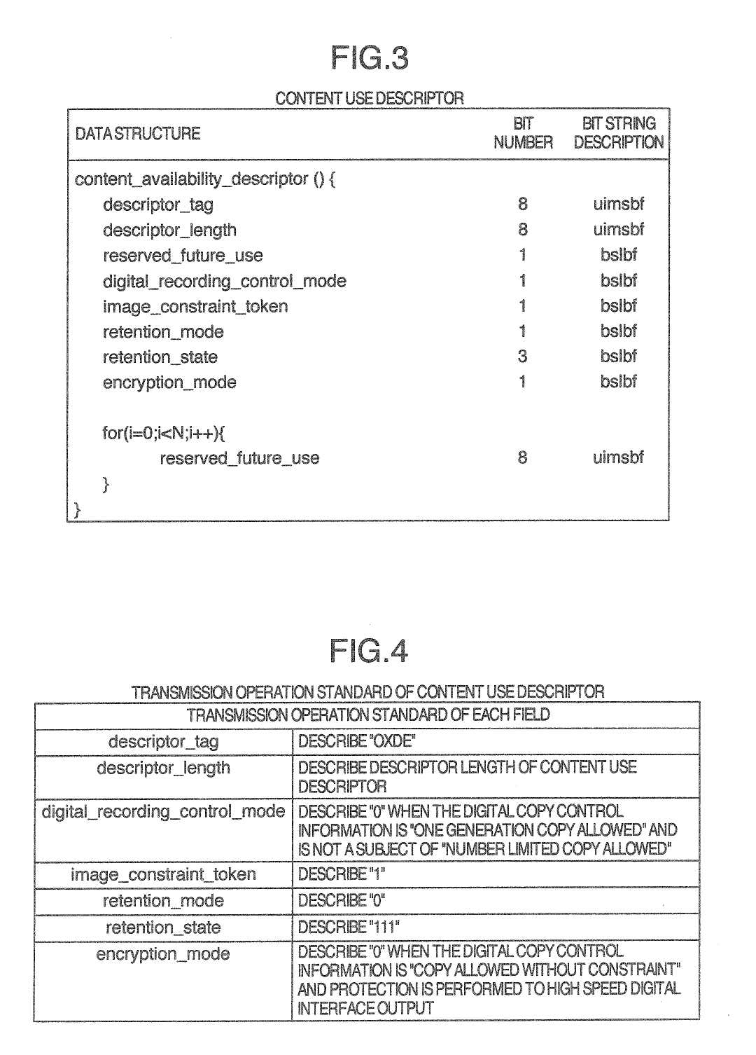

FIG. 3 shows one example of a structure of the content use descriptor which is one of copy control information. The content use descriptor is, for example, information which is generated and added at the management information giving unit 16, stored in PSI (Program Specific Information) (as one example, PMT (Program Map Table) and the like) of EG-TS, or SI (Service Information) (as one example, EIT (Event Information Table)), or SDT (Service Description Table) or the like), and transmitted.

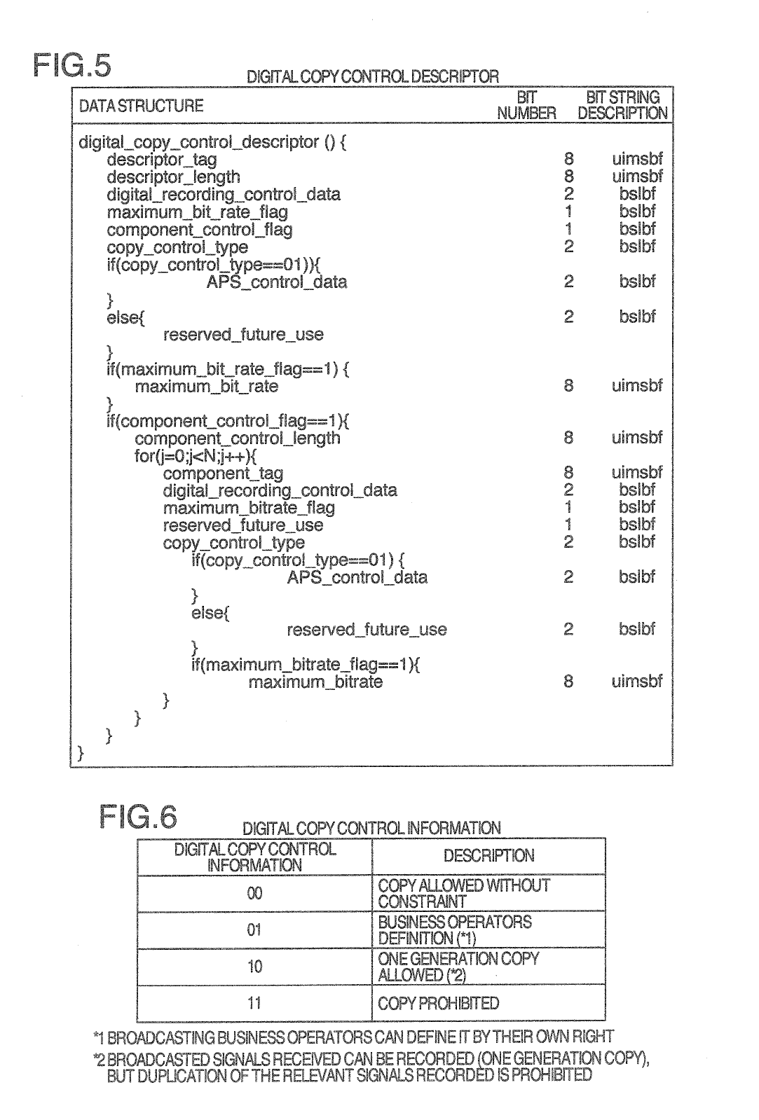

Applications of the content use descriptor are those to be arranged (transmitted) in the case of describing control information on accumulation (recording) or output for the relevant programs. The meaning thereof is, when 1-bit field of digital_recording_control_mode (digital copy mode bit) is “1”, it shows recordable as “Number Limited Copy Allowed” even when digital_recording_control_data of the digital copy control descriptor to be explained in FIG. 5 is “One Generation Copy Allowed”, while when it is “0”, recording as “Number Limited Copy Allowed” is not allowed.

It should be noted that, the content use descriptor is surely arranged (transmitted), when the relevant programs are subjects of output protection. This output protection means that protection is performed for a high speed digital interface output of content with “copy allowed without constraint condition”, using an output protection bit (encryption_mode) of the content use descriptor. In other words, in output in the digital interface or copy to a recording medium, it is encrypted, however, limitation is not imposed on number or generation of copy. Re-transmission to Internet becomes impossible actually. It is also called “copy free with output protection” or EPN (encryption plus non-assertion).

In addition, it is surely arranged (transmitted), when the digital copy control information of the relevant programs is “One Generation Copy Allowed”, and is not a subject of “Number Limited Copy Allowed”.

FIG. 4 shows one example of description in each field of the content use descriptor.

In “descriptor_tag”, “OxDE” is described, which means the content use descriptor. In “descriptor_length”, descriptor_length of the content use descriptor is described.

In “digital_recording control_mode”, “0” is described when the digital copy control information is “One Generation Copy Allowed” and is not a subject of “Number Limited Copy Allowed”, and “1” is described when the digital copy control information is “One Generation Copy Allowed” and is a subject of “Number Limited Copy Allowed”.

In “encryption_mode”, “0” is described when the digital copy control information is “Number Limited Copy Allowed” and protection is performed to high speed digital interface output.

“Retention_mode” means a temporary accumulation control bit, and “0” is described which expresses that temporary accumulation is possible even when “digital_recording_control_data” (digital copy control information) of the digital copy control descriptor is “Copy prohibited”. “Retention_state” means a temporary accumulation allowed time, and “111” is described which expresses accumulation is possible for 1 hour and 30 minutes. It should be noted that, “image_constraint_token”, “retention_state”, “encryption_mode” are “1” in a default state.

Copy number of content with “Number Limited Copy Allowed” is limited to within 10 as total number of copies including a copy source and a copy destiny. In addition, when recording function to a removable recording medium, or move function via high speed digital interface output is present, it is limited including them. Specifically, for example, as for content of the copy source and the copy destiny, copy number shall be limited or copy shall be prohibited (Re-Copy Prohibited) excluding analogue picture, audio output and digital audio output, by each side. Content of the copy source or the copy destiny may be moved as long as it is within the above limit.

It should be noted that, one used only for content management like thumbnail shall not be included in copying.

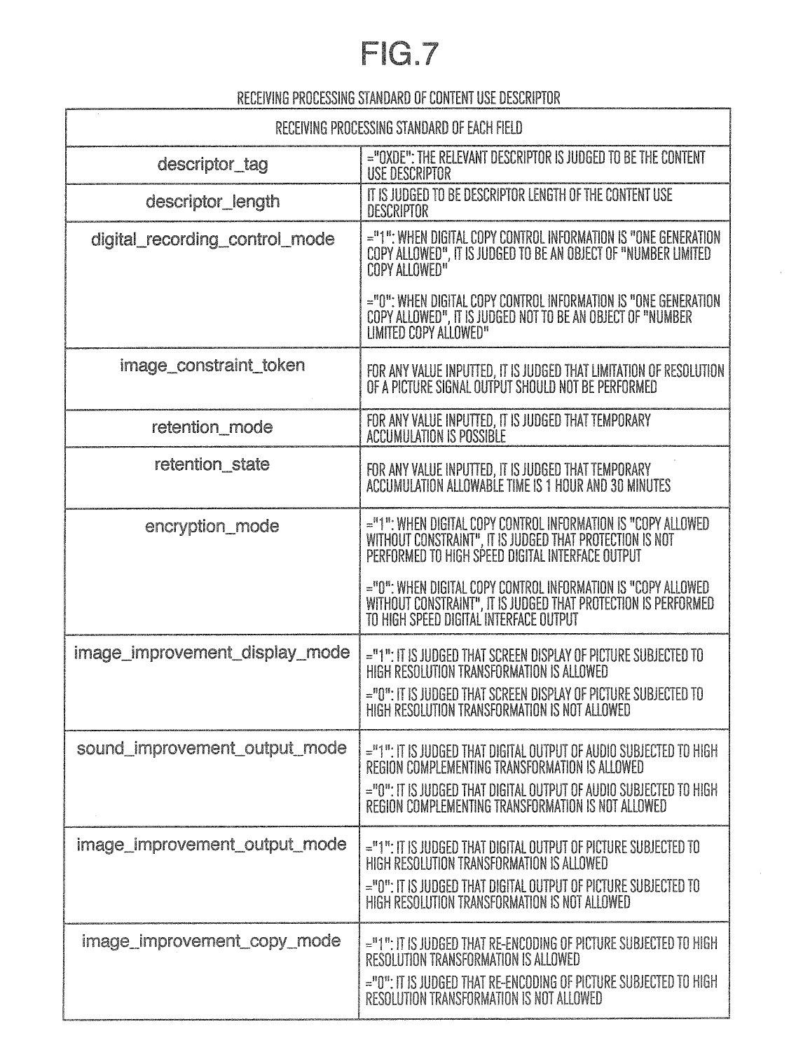

Description will be given later on each field as processing of the receiving side, also in FIG. 7.

FIG. 5 shows one example of a structure of the digital copy control descriptor which is one of copy control information. The digital copy control descriptor is information, for example, generated and added at the management information giving unit 16, and stored in PSI (PMT or the like as one example) or SI (EIT or SDT or the like as one example) of MPEG-TS, and transmitted.

The digital copy control descriptor expresses information for controlling copy generation by a two-bit field of “digital_recording_control_data” (digital copy control information).

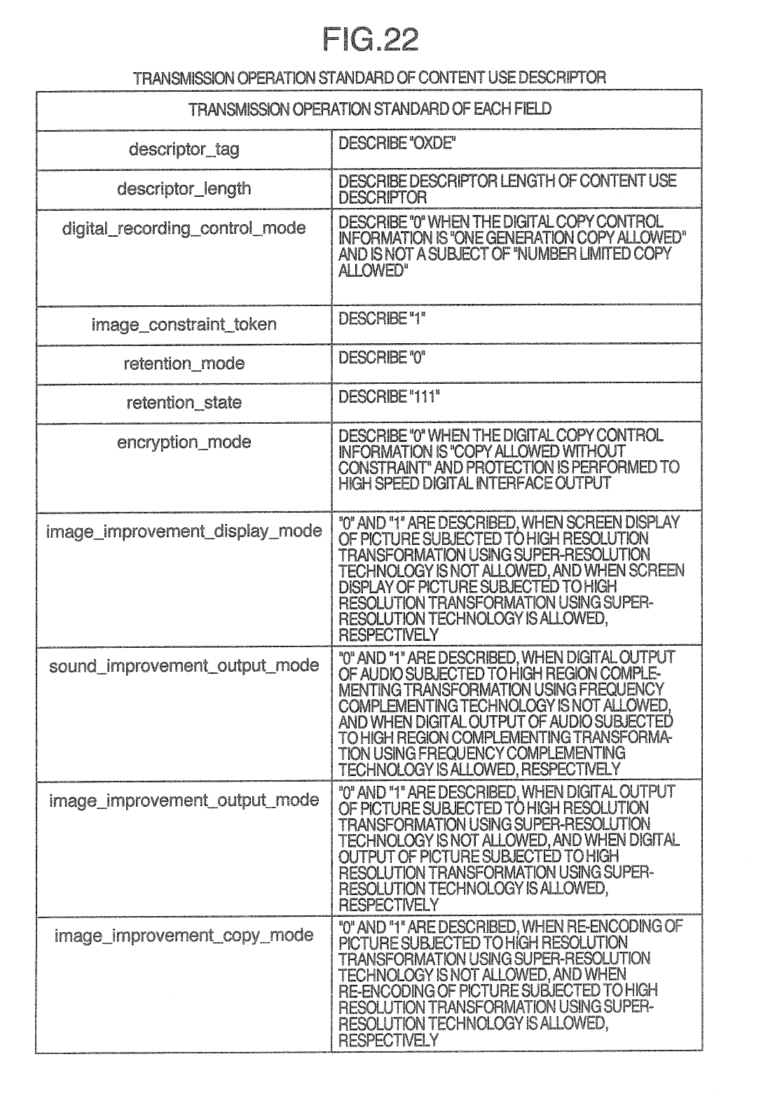

FIG. 6 shows an example of digital copy control information. When the digital copy control information is “00”, “01”, “10” and “11”, it expresses “copy allowed without constraint condition”, “copy depends on definition of a broadcasting enterprise”, “One Generation Copy Allowed” and “copy prohibited”, respectively. It should be noted that, “One Generation Copy Allowed” means that broadcasted signals received can be recorded (one generation copy) but duplication (copy) of the broadcasted signals after recording is not allowed. FIG. 22 shows one example of description content of the content use descriptor in each field.

Because “descriptor_tag”, “descriptor_length”, “digital_recording_control_mode”, “image_constraint_token”, “retention_mode”, “retention_state”, “retention_state” “encryption_mode” have the same description content as explained in FIG. 4, explanation will be omitted here. Explanation will be given below on fields of “image_improvement_display_mode”, “sound_improvement_output_mode”, “image_improvement_output_mode” and “image_improvement_copy_mode”.

In “image_improvement_display_mode”, “0” and “1” are described, when display in a screen of picture subjected to high resolution transformation using super-resolution technology is not allowed, and when display in a screen of picture subjected to high resolution transformation using super-resolution technology is allowed, respectively.

In “sound_improvement_output_mode”, “0” and “1” are described, when digital output of audio subjected to high region complementing transformation using frequency complementing technology is not allowed, and when digital output of audio subjected to high region complementing transformation using frequency complementing technology is allowed, respectively.

In “image_improvement_output_mode”, “0” and “1” are described, when digital output of picture subjected to high resolution transformation using super-resolution technology is not allowed, and when digital output of picture subjected to high resolution transformation using super-resolution technology is allowed, respectively.

In “image_improvement_copy_mode”, “0” and “1” are described, when re-encoding of picture subjected to high resolution transformation using super-resolution technology is not allowed, and when re-encoding of picture subjected to high resolution transformation using super-resolution technology is allowed, respectively.

It should be noted that, the above high resolution transformation means transformation for improving to higher resolution than resolution of picture of original content sent from a broadcasting station. In addition, the above high region complementing transformation means transformation for improving audio band region in a higher region direction than an audio band region of audio of original content sent from a broadcasting station.

In addition, although not described in FIG. 22, it is also possible to set a field with a content describing “0” and “1” when re-encoding of audio subjected to high region complementing transformation using high region complementing technology is not allowed, and when re-encoding of audio subjected to high region complementing transformation using high region complementing technology is allowed, respectively.

Further, although not described in FIG. 22, it is also possible to set a field with a content describing “0” and “1” when analogue outputting of audio subjected to high region complementing transformation using high region complementing technology is not allowed, and when analogue outputting of audio subjected to high region complementing transformation using high region complementing technology is allowed, respectively.

In addition, in explanation of FIG. 22, the field of “image_improvement_display_mode”, “sound_improvement_output_mode”, “image_improvement_output_mode”, and “image_improvement_copy_mode” had content showing whether screen display, digital output, analogue output and re-encoding after subjected to high resolution transformation or high region complementing transformation is allowed or not, however, it is also possible to set a field with a content showing specifically limitation value (for example, equal to or smaller than 1920×1080) of transformable resolution, in the case of high resolution transformation, and limitation value (for example, equal to or smaller than 20 kHz) of high region frequency in the case of high region complementing transformation.

In this way, by setting whether screen display, digital output, analogue output and re-encoding after subjected to high resolution transformation or high region complementing transformation is allowed or not; limitation value of transformable resolution, in the case of high resolution transformation; and limitation value of high frequency in the case of high region complementing transformation; at a content transmitting side and transmitting the content, a content receiving side becomes possible to perform receiving processing, based on the content set by the content transmitting side, and thus in the case of displaying, recording and outputting content by a receiving apparatus, enhancement of usability can be attained, while performing display control, recoding limitation, output limitation and copy control, in consideration of intention of content providers or copyright owners, and thus there is effect to attain content protection while attaining convenience of a user.

The content use descriptor of FIG. 3, FIG. 4 and FIG. 22 is also called copy number control information, and the digital copy control information of FIG. 5 and FIG. 6 is also called copy generation control information.

In addition, “image_improvement_display_mode”, “sound_improvement_output_mode”, “image_improvement_output_mode”, and “image_improvement_copy_mode” of the content use descriptor of FIG. 22 are also called output control information.

### <Receiver>

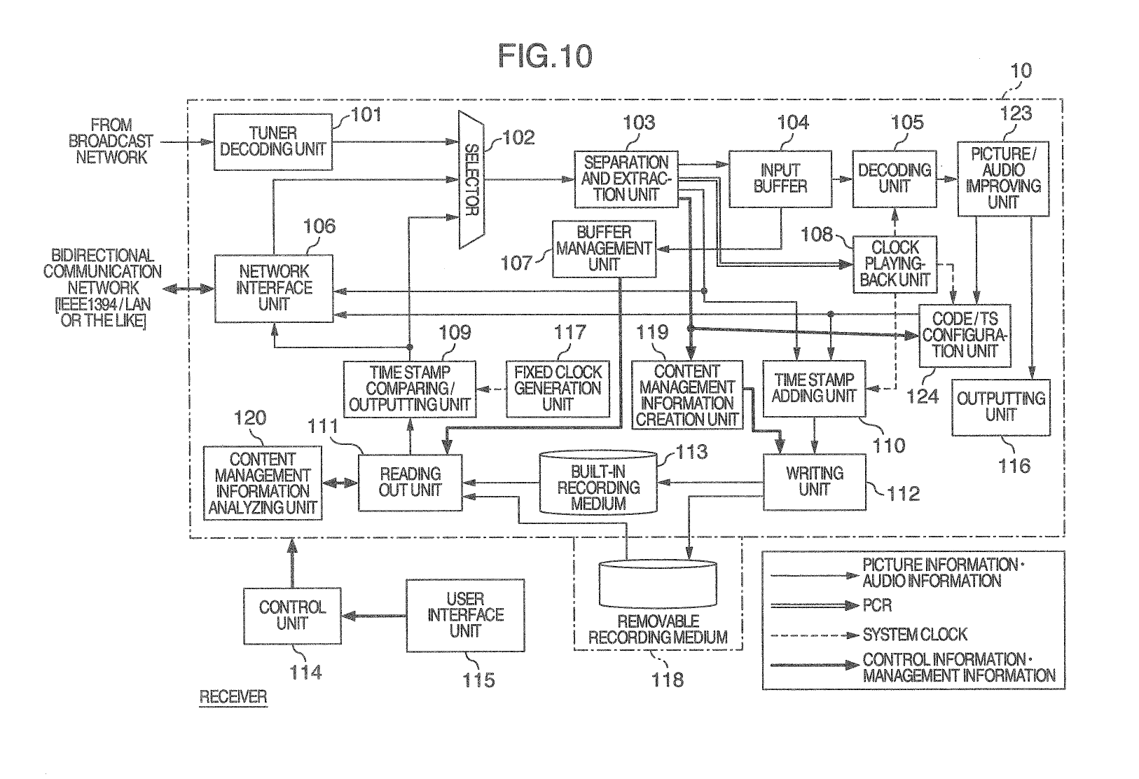

FIG. 10 is a block chart showing a configuration example of the receiver 3 in the system of FIG. 1. In FIG. 10, a place where lines showing the flow of information, PCR or the like cross shall be construed not to contact each other, however, a part marked with a black dot shall be construed to contact each other and branch from there.

The receiver 3 is a receiver for receiving digital broadcasting or IP (Internet Protocol) broadcasting via a network, and performing recording and playback. Explanation will be given on the case of handling signals encoded by an MPEG (Moving Picture Experts Group) system, as image compression technology, and multiplexed by an MPEG2-TS system.

The receiver 3 includes the received record playing-back unit 10, a control unit 114 (for example, CPU (Central Processing Unit)) and a user interface unit 115 (for example, a keyboard, a mouse or a remote controller or the like, as an input device).

The present configuration example describes each as a hardware element, however, a part thereof may be attained by a software. In addition, it may be applied to transmitting and receiving the picture content, the audio content and the like to a specified user, such as VOD (Video On Demand) or downloading via a network or the like. They may also be called delivery generically.

The control unit 114 is connected with each unit (including the received record playing-back unit 10) of the present receiver by a bus unit, and controls action of the whole receiver. In addition, various processing are performed by receiving various command signals from a user via a remote controller or the like of the user interface unit 115, and by controlling each unit connected via the bus unit, based on the command signals thereof.

The received record playing-back unit 10 includes a tuner decoding unit 101, a selector 102, a separation and extraction unit 103 (for example, a de-multiplexer), an input buffer 104, a decoding unit 105 (for example, an MPEG decoder), a network interface unit 106, a buffer management unit 107, a clock playing-back unit 108, a time stamp comparing/outputting unit 109, a time stamp adding unit 110, a reading out unit 111, a writing unit 112, a built-in recording medium 113, an outputting unit 116, a fixed clock generation unit 117 (for example, a crystal oscillator), a content management information creation unit 119, a content management information analyzing unit 120, a picture/audio improving unit 123, and a code/TS configuration unit 124.

The built-in recording medium 113 (which may also be called the first recording medium) and a removable recording medium 118 (which may also be called the second recording medium) are random accessible media, for example, a hard disk drive (HDD), a semiconductor memory, a magnetic disk, an optical disk, an magneto-optical disk or the like.

The outputting unit 116 is a composite picture output terminal, an S picture output terminal (S terminal), a D picture output terminal (D terminal) (they are analogue picture output terminals), an HDMI (High Definition Multimedia Interface) output terminal (digital picture output terminal), an optical audio output terminal (digital audio output terminal) or the like, for outputting the analogue or digital picture data/audio data to a display unit utilizing CRT (Cathode Ray Tube), LCD (Liquid Crystal Display), PDP (Plasma Display Panel) or the like, an audio output unit by a speaker or the like, or other display devices or the like. The outputting unit 116 reproduces high resolution picture/high region complementing audio with improved picture quality and audio quality at the picture/audio improving unit 123, at a display unit/audio output unit of an output device. Alternatively, it outputs picture/audio content data or the like to other display devices, an audio playing-back device or the like via the output terminal (for example, HDMI) or the like. To the picture/audio content data from this output terminal, content protection is performed so as to be outputted in a format based on a content protection system of each output specification.

The tuner decoding unit 101 receives digital broadcasting signals transmitted from the transmitter 1 via a broadcast transmitting network such as radio (satellite, terrestrial), a cable. Station selection and detection processing are made to physical or virtual channel frequency, which is specified via a user operation unit and the control unit 114 such as a remote controller of a user interface unit 115. In addition, MPEG2-TS (transport stream), after subjected to digital de-modulation and error correction processing, is outputted to the selector 102.

The selector 102 performs selection processing of 3 input and 1 output, according to control from the control unit 114, and outputs the output thereof to the separation and extraction unit 103.

The separation and extraction unit 103 separates and extracts a transport packet of a channel (program), which is specified via a user operation unit and the control unit 114 such as a remote controller of the user interface unit 115, from MPEG2-TS inputted, and outputs thus separated and extracted transport packet to the time stamp adding unit 110 and the network interface unit 106. In addition, the separation and extraction unit 103 separates and extracts PES (Packetized Elementary Stream) or ES (Elementary Stream) of video and audio from the transport packet of a channel (program), which is specified via a user operation unit and the control unit 114 such as a remote controller of the user interface unit 115, and outputs it to the input buffer 104.

ES means each of compressed and encoded video and audio data, and PES means a packetized one obtained by dividing a picture ES or audio ES to a suitable size. In addition, the separation and extraction unit 103 extracts PCR (Program Clock Reference) from the transport packet of a channel (program), which is specified via a user operation unit and the control unit 114 such as a remote controller of the user interface unit 115, and outputs to the clock playing-back unit 108.

The separation and extraction unit 103 detects titles of channels (programs) or start and end date of the programs, copy generation control information and copy number control information, which are recorded from PSI or SI of the transport packet of the channel (program), which is specified via a user operation unit and the control unit 114 such as a remote controller of the user interface unit 115, to the built-in recording medium 113 or the removable recording medium 118, or outputted to the outputting unit 116 or the network interface unit 106, outputs them to the code/TS configuration unit 124, and still more creates an encryption key of a data and outputs them to the content management information creation unit 119. These titles or start and end date of the programs, copy generation control information and copy number control information are stored, for example, in PSI or SI information of MPEG-TS, and transmitted from the transmitter 1.

The input buffer 104 temporarily stores PES or ES of picture/audio from the separation and extraction unit 103. The decoding unit 105 takes out and decodes PES or ES of picture/audio stored in the input buffer 104, by comparing DTS (Decoding Time Stamp)/PTS (Presentation Time Stamp) corresponding to PES or ES stored in the input buffer 104, and STC (System Time Clock) count value from the clock playing-back unit 108, and by taking timing of decoding and display, and the decoded picture/audio is outputted to the picture/audio improving unit 123.

The picture/audio improving unit 123 improves picture quality and audio quality to high resolution picture subjected to high resolution transformation the picture/audio decoded at the decoding unit 105 using super-resolution technology, and to high region complementing audio subjected to high region complementing transformation using high region complementing technology, and the high resolution picture/high region complementing audio with thus improved picture quality and audio quality are outputted to the outputting unit 116 and the code/TS configuration unit 124.

The code/TS configuration unit 124 compresses the high resolution picture/high region complementing audio with improved picture quality and audio quality at the picture/audio improving unit 123, to an H.264 system or an MPEG system, and generates DTS/PTS corresponding to PES using STC count value from the clock playing-back unit 108; then configures PES and creates PSI and SI using titles of channels (programs) or start and end date of the programs, copy generation control information and copy number control information from the separation and extraction unit 103. And, it generates a transport packet in accordance with an MPEG2-TS system, and outputs it to the time stamp adding unit 110 and the network interface unit 106.

The buffer management unit 107 monitors amount of unprocessed transport packet at the decoding unit 105 in the input buffer 104, and controls read out start and stop of the reading out unit 111 depending on the amount thereof.

The clock playing-back unit 108 reproduces a system clock of the receiver with frequency coincident with, for example, a system clock of an encoding and multiplexing unit at the transmitter 1 side not shown, utilizing PCR. The reproduced system clock is outputted to an STC counter inside the clock playing-back unit 108, the time stamp adding unit 110 or the like. In addition, STC count number of the STC counter which operates by the reproduced system clock is outputted to the decoding unit 105 and the code/TS configuration unit 124.

The time stamp adding unit 110 generates a time stamp by a counter, which operates, for example, based on the system clock reproduced at the clock playing-back unit 108, or a crystal oscillator not shown, adds this time stamp each to the transport packet separated and extracted at the separation and extraction unit 103, or the transport packet generated at the code/TS configuration unit 124, and outputs it to the writing unit 112.

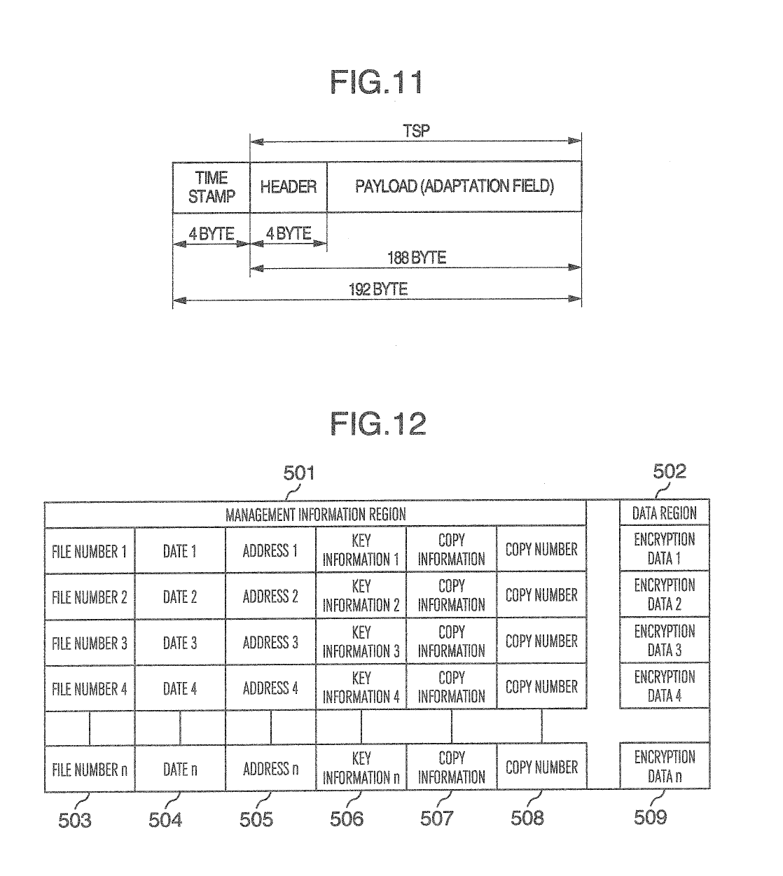

FIG. 11 shows a structure example of the transport packet added with the time stamp. A transport packet (TSP) with a length of 188 bytes in an EG standard is added with a time stamp (for example, time when a receiving apparatus received the transport packet) with 4 prologue bytes, to be converted to a packet with a length of 192 bytes. In the time stamp, time stamp information at the time when that transport packet arrived, is retained. TS of the MPEG standard is composed of a header of 4 prologue bytes, and subsequent 184-byte payload (or adaptation field).

The content management information creation unit (content information creation unit) 119 creates management information based on titles or start and end date of the programs, copy generation control information and copy number control information, and key information from the separation and extraction unit 103, and outputs them to the writing unit 112. The copy generation control information and the copy number control information may be used as management information as they are, by receiving the content use descriptor and the digital copy control descriptor explained in FIG. 3 to FIG. 6, from the transmitting apparatus 1, or may be created as new information based on these.

The writing unit 112 performs processing for recording management information created at the content management information creation unit 119, and encrypted data subjected to encryption processing based on the key information in the above management information, for the transport packet added with the time stamp at the time stamp adding unit 110, in the built-in recording medium 113 or the removable recording medium 118. As a result, one stream having encrypted data subjected to encryption processing for the transport packet added with a plurality of time stamps containing picture/audio data of a certain channel (in other words, certain program content, download content), is memorized in the built-in recording medium 113 or the removable recording medium 118, as one data file or two or more fraction data files where it is divided.

It should be noted that, the time stamp may be said time information relating to temporal position of the transport packet to be added with the stamp. For example, it may also be said time when the transport packet was inputted from the separation and extraction unit 103 to the time stamp adding unit 110, or temporal difference from a certain transport packet (for example, a transport packet just before or at the most head position) of standard. This time stamp is different, as described above, from a time stamp (for example, PCR or DTS or PTS) contained in the transport packet in advance.

FIG. 12 shows a recording example of program content to the built-in recording medium 113 or the removable recording medium 118.

By each of the program content, management information showing detail of the program content, and data (picture, audio or the like) of an entity of the program content are recorded in a management information region 501 and a data region 502, respectively. In management information, for example, a file number 503 showing titles of the program content, a date 504 showing start and end date of programs showing start and end date of the programs, a prologue address of the data region and record size 505, a copy information 507, a copy number 508, and key information 506 or the like are recorded. In the data region 502, the program content is written from an address corresponding to the prologue address 505 recorded in the management information region 501. Every time when program content are recorded newly, management information and the program content are sequentially recorded, like file number 1, file number 2, - - - , file number n.

The copy information 507 is copy generation control information contained in management information created at the content management information creation unit 119, and the following designations, for example, by two-bit signals, are considered:

00=Copy Possible (Copy Free)

10=One Generation Copy Allowed (Copy One Generation)

11=Copy Prohibited (Copy Never)

In this case, for program content recorded with “Copy One Generation” in the receiver 3, it is defined, by 01=“Copy One Generation”, that those copied once cannot be copied further (No More Copies). A way of designation may be the same operation as digital copy control information explained in FIG. 6, or may be operated uniquely by the receiver 3.

The copy number 508 is copy number control information contained in management information created at the content management information creation unit 119. The copy number 508 is information created at the content management information creation unit 119, based on copy generation control information and copy number control information (information showing whether a plurality of copies are allowed or not) received from the separation and extraction unit 103. When copy generation control information is One Generation Copy Allowed (Copy One Generation) and information showing whether a plurality of copies are allowed or not is “allowed”, the program content are recorded as “No More Copies”; information showing copy allowable number for making copy possible in the same or different format is stored in the same or different recording medium; and for example, “9” is inputted showing the meaning that 9 copies are allowed. This numerical value may be in accordance with standards and the like. On the other hand, when copy generation control information is One Generation Copy Allowed (Copy One Generation) and information showing whether a plurality of copies are allowed or not is “not allowed”, the program content are recorded as “No More Copies”, and “0” (showing the meaning that copy is not allowed) is inputted, as information showing copy allowable number for making copy impossible.

It should be noted that, data which is entity of the program content, where the program content of “Copy One Generation” are recorded as “No More Copies”, that is, copy generation control information and copy number control information (information showing whether a plurality of copies are allowed or not) stored in PSI or SI of MPEG-TS and transmitted from the transmitter 1, should not be altered.

In addition, the copy information 507, the copy number 508, and the key information 506 are, for example, encrypted, so as not to be manipulated.

Further, as management information showing detail of program content of FIG. 12, information showing whether screen display of picture subjected to high resolution transformation using super-resolution technology is allowed or not; information showing whether digital output of audio subjected to high region complementing transformation using high region complementing technology is allowed or not; information showing whether digital output of picture subjected to high resolution transformation using super-resolution technology is allowed or not; information showing whether re-encoding of picture subjected to high resolution transformation using super-resolution technology is allowed or not; information showing whether re-encoding of audio subjected to high region complementing transformation using high region complementing technology is allowed or not; information showing whether analogue output of audio subjected to high region complementing transformation using high region complementing technology is allowed or not; limitation value of transformable resolution for the case of high resolution transformation; and limitation value of high region frequency for the case of high region complementing transformation; and the like, which are sets of information contained in copy number control information, other than explained above, may also be made as management information.

Returning to explanation of FIG. 10, when the content management information analyzing unit 120 reads out management information memorized in the built-in recording medium 113 or the removable recording medium 118, via the reading out unit 111, analyzes the content of the management information thereof and performs playback, copy or move of program content memorized in the built-in recording medium 113 or the removable recording medium 118, so that the program content can be selected via the user operation unit and the control unit 114 such as a remote controller of the user interface unit 115, titles of program content or start and end date of the programs, copy information, copy number, information showing whether screen display, digital output, analogue output and re-encoding after subjected to high resolution transformation or high region complementing transformation are possible or not, or the like is delivered to the control unit 114. In addition, key information for encoding encrypted data is delivered to the reading out unit 111.

The reading out unit 111 is controlled via the buffer management unit 107 or the control unit 114, reads out management information from the built-in recording medium 113 or the removable recording medium 118, outputs it to the content management information analyzing unit 120, sequentially reads out encrypted data from the built-in recording medium 113 or the removable recording medium 118, and outputs the transport packet added with the time stamp subjected to encryption processing for the encrypted data to the time stamp comparing/outputting unit 109, based on key information delivered from the content management information analyzing unit 120.

The time stamp comparing/outputting unit 109 compares counter value of the counter which actions based on the fixed clock generation unit 117 such as a crystal oscillator, with the time stamp of the transport packet added with the time stamp read out at the reading out unit 111, and when they are coincident, deletes (removes) the time stamp from the transport packet, and outputs it to the selector 102, and the network interface unit 106. It should be noted that, as described above, when residual amount of the input buffer 104 is monitored at the buffer management unit 107, and the reading out unit 111 is controlled in response to the amount thereof, the time stamp may be deleted from the transport packet without comparing the counter value with the time stamp, and it may be output to the selector 102 and the network interface unit 106. In particular, in playback other than normal playback (normal speed playback), it is preferable to output by this method.

The network interface unit 106 is connected with other devices (a recording device or a display, a personal computer or the like in premises, or an exterior server or the like) of sink/source, via a line (an IEEE1394 cable or a LAN cable or wireless LAN or the like). And, by receiving the transport packet of picture/audio or the like deleted the time stamp at the time stamp comparing/outputting unit 109, or the transport packet separated and extracted at the separation and extraction unit 103, and the transport packet generated at the code/TS configuration unit 124, these transport packets are transformed to a format in corresponding to each transmission standard, via the line, and picture/audio data memorized in the built-in recording medium 113 and the removable recording medium 118, or picture/audio data of digital broadcasting signals received at the tuner decoding unit 101 is outputted to other devices of sinks. In addition, data such as picture/audio is inputted in a format corresponding to each transmission standard, via the line, from other devices as sources, to be transformed to the transport packet and is outputted to the selector 102. It should be noted that, the network interface unit 106 may be present in multiple.

### <Receiving and Recording Processing Relating to Copy Control Information>

Explanation will be given on detailed examples of processing of the receiver 3 relating to copy control information explained in FIGS. 3 to 6, and 22, transmitted from the transmitter 1.

FIG. 7 shows one processing example of the content use descriptor to each field in the receiver 3.

When “descriptor_tag” is “OxDE”, the relevant descriptor is judged to be the content use descriptor. It is judged to be descriptor length of the content use descriptor, by “descriptor_length”. When “digital_recording_control_mode” is “1”, and when digital copy control information is “One Generation Copy Allowed”, it is judged to be an object of “Number Limited Copy Allowed”. When it is “0”, and when digital copy control information is “One Generation Copy Allowed”, it is judged not to be an object of “Number Limited Copy Allowed”.

As for “image_constraint_token”, for any value inputted, it is judged that limitation of resolution of a picture signal output should not be performed. As for “retention_mode”, for any value inputted, it is judged that temporary accumulation is possible. As for “retention_state”, for any value inputted, it is judged that temporary accumulation allowable time is 1 hour and 30 minutes. When “encryption_mode” is “1”, and when digital copy control information is “Copy allowed without constraint”, it is judged that protection is not performed to high speed digital interface output. When it is “0”, and when digital copy control information is “Copy allowed without constraint”, it is judged that protection is performed to high speed digital interface output.

When “image_improvement_display_mode” is “1”, it is judged that screen display of picture subjected to high resolution transformation using super-resolution technology is allowed. And, the picture/audio improving unit 123 performs transformation of higher resolution than resolution of original content transmitted from a broadcasting station, and outputs it to the outputting unit 116, and the picture transformed to higher resolution is displayed on a screen of the outputting unit 116. When it is “0”, it is judged that screen display of picture subjected to high resolution transformation using super-resolution technology is not allowed. And, the picture/audio improving unit 123 performs transformation of resolution equivalent to or lower than resolution of original content transmitted from a broadcasting station, outputs it to the outputting unit 116, and the resolution transformed picture is displayed on a screen of the outputting unit 116.

When “sound_improvement_output_mode” is “1”, it is judged that digital output of audio subjected to high region complementing transformation using high region complementing technology is allowed. In addition, the picture/audio improving unit 123 performs transformation to improve higher frequency components than high frequency of original content transmitted from a broadcasting station, outputs them to the outputting unit 116, and the improved and transformed audio in high frequency components is outputted to digital output of the outputting unit 116. When it is “0”, it is judged that audio subjected to high region complementation transformation using high region complementation technology is not allowed to be digitally outputted. And, the picture/audio improving unit 123 performs transformation of high frequency components of equivalent to or lower than high frequency of original content transmitted from a broadcasting station, and outputs it to the outputting unit 116, and the transformed audio in high frequency components is outputted to digital output of the outputting unit 116.

When “image_improvement_output_mode” is “1”, it is judged that digital output of picture subjected to high resolution transformation using super-resolution technology is allowed. And, the picture/audio improving unit 123 performs transformation of higher resolution than resolution of original content transmitted from a broadcasting station, and outputs it to the outputting unit 116, and the picture transformed to higher resolution is outputted to the digital output of the outputting unit 116. When it is “0”, it is judged that digital output of picture subjected to high resolution transformation using super-resolution technology is not allowed. And, the picture/audio improving unit 123 performs transformation of resolution equivalent to or lower than resolution of original content transmitted from a broadcasting station, outputs it to the outputting unit 116, and the resolution transformed picture is outputted to the digital output of the outputting unit 116.

When “image_improvement_copy_mode” is “1”, it is judged that re-encoding of picture subjected to high resolution transformation using super-resolution technology is allowed. And, the picture/audio improving unit 123 performs transformation of higher resolution than resolution of original content transmitted from a broadcasting station, and outputs it to the code/TS configuration unit 124, and the high resolution transformed picture is re-encoding processed at the code/TS configuration unit 124 and outputted to the time stamp adding unit 110 and the network interface unit 106, and accumulated (recorded) in a recording medium, or outputted to a device connected to a receiving apparatus via a network. When it is “0”, it is judged that re-encoding of picture subjected to high resolution transformation using super-resolution technology is not allowed. And, the picture/audio improving unit 123 performs transformation of resolution equivalent to or lower than resolution of original content transmitted from a broadcasting station, and outputs it to the code/TS configuration unit 124, and the high resolution transformed picture is re-encoding processed at the code/TS configuration unit 124, outputted to the time stamp adding unit 110 and the network interface unit 106, and accumulated in a recording medium, or outputted to a device connected to a receiving apparatus via a network.

It should be noted that, when the content use descriptor is not arranged (transmitted) for some reason or other, it may be construed that each field has the following value: digital_recording_control_mode=‘1’, image_constraint_token=‘1’, retention_mode=‘0’, retention_state=‘111’, encryption_mode=‘1’, image_improvement_display_mode=‘1’, sound_improvement_output_mode=‘1’, image_improvement_output_mode=‘1’, and image_improvement_copy_mode=‘1’.

In this way, receiving processing becomes possible at the receiving side, based on content set at the content transmitting side, on whether screen display, digital output and re-encoding after subjected to high resolution transformation or high region complementing transformation of content which is set at the content transmitting side, is allowed or not, and in displaying, recording and outputting content using a receiving apparatus, enhancement of usability can be attained, while performing display control, recoding limitation, output limitation and copy control, in consideration of intention of content providers or copyright owners, and thus there is effect to attain content protection while attaining benefit of a user.

FIG. 9 shows a control example for accumulating (recording) program content by utilizing copy control information by the receiver 3.

As for content shown by FIG. 9, for example, in accumulating program content, when digital_recording_control_data of the digital copy control descriptor is “10” and “One Generation Copy Allowed”, copy control information on a recording medium is accumulated as “Re-Copy Prohibited”. However, when digital_recording_control_mode is “1”, it is accumulated as “Number Limited Copy Allowed”. It should be noted that, also in performing the accumulation as “Re-Copy Prohibited”, value of digital_recording_control_data of the digital copy control descriptor may not be altered.

In addition, when digital_recording_control_data of the digital copy control descriptor is “10”, and “One Generation Copy Allowed”, a plurality of copies should not be generated. However, it excludes the accumulation to an area to which a user cannot access for aiming at back up. In addition, the above limitation should be imposed by each receiving unit of broadcasting, and when a plurality of receiving units of broadcasting are present, the above limitation should be imposed by each receiving unit of one broadcasting.

As for “Number Limited Copy Allowed”, from the program content accumulated as “Number Limited Copy Allowed”, N pieces of copies can be generated. Value of N, for example, may be in accordance with a standard. In generating copies via high speed digital interface output, when copy number to be generated can be determined definitely by using move function or the like, copy may be allowed. For example, it is the case where it is recognized that an interface is IEEE1394, and a sink is a device corresponding to the DTCP standard. It should be noted that, the copies generated should be in a “Re-Copy Prohibited” state or in an state equivalent thereto.

In addition, when the program content accumulated as “Number Limited Copy Allowed” are reproduced and outputted, in a high speed digital interface, it is outputted by performing “No More Copies” processing specified in DTCP (Digital Transmission Content Protection). Analogue picture output and digital audio output may be outputted as “One Generation Copy Allowed”.

Number of copies of content with “Number Limited Copy Allowed” is limited to within 10 as total copy numbers including at a copy source and a copy destiny. In addition, in the case where recording function to a removable recording medium, or move function via high speed digital interface output is present, it is limited with including them. Specifically, for example, the content of the copy source and copy destiny should be limited in copy number or prohibited copy itself (Re-Copy Prohibited), each excluding analogue video and audio output, and digital audio output. As long as it is within the above limit, the content of the copy source and copy destiny may be moved.

As for content recorded (accumulated) as “Number Limited Copy Allowed”, generation of up to 9 copies is allowed for digital recording (copy) to a recording medium, and copy via high speed digital interface output, other than original content recorded (accumulated). However, it excludes the recording (accumulation) to an area to which a user cannot access for aiming at back up, in recording and after recording. The original content after generation of copies of specified number (9) can be moved similarly as content with “Re-Copy Prohibited”.

As for content recorded (accumulated) as “Number Limited Copy Allowed”, all or a part of copy numbers managed can be moved to a built-in or digitally connected recording medium corresponding to digital_recording_control_mode. However, in this case, total copy number should not be altered before and after the move.

Management of copy number in copy of content of “Number Limited Copy Allowed” to a built-in recording medium and copy via high speed digital interface is equivalent to the case where 10 movable contents are present. In addition, analogue picture output and digital audio output can be outputted with “Only One Generation Copy Allowed”, and not included in limitation of copy number.

As for recording to the removable recording medium, content can be recorded in a state of “Number Limited Copy Allowed”, as long as management of copy number equivalent to the above explanation is possible.

As for content of “Number Limited Copy Allowed”, when all or a part of copy numbers managed by a move source is moved, total movable copy number should not be altered before and after the move. Specifically, when number of movable content of content before the move is 10, and 4 among them are moved, number of movable content in content of a move source should be 6.

It should be noted that, one used only aiming at managing content like the thumbnail should not be included in copy. One used only aiming at managing content may be, for example, one which utilizes audio information, or one which utilizes caption information, other than the thumbnail created from picture information.

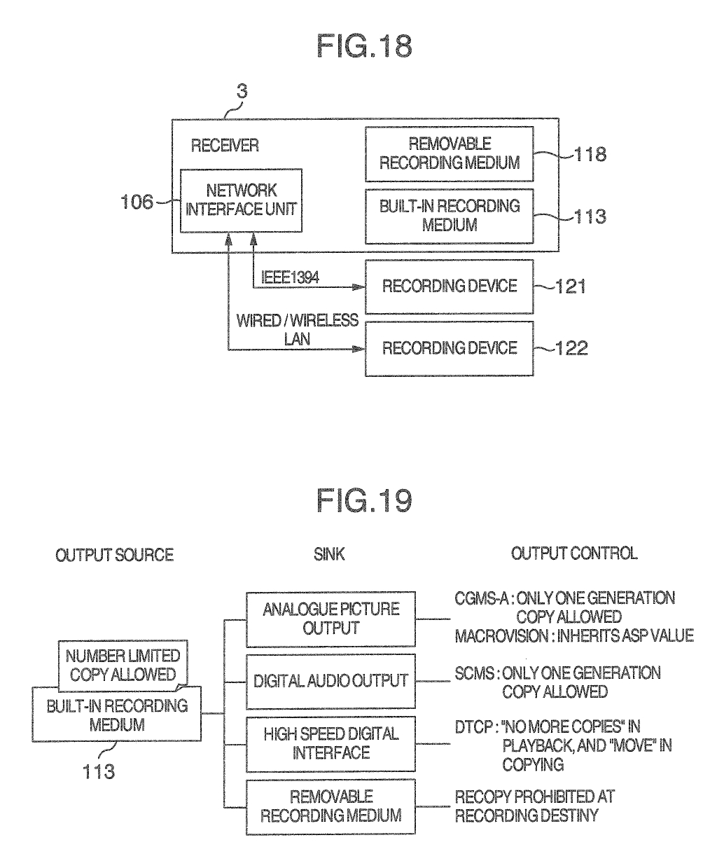

FIG. 18 is a drawing for understanding limitation of copy number explained above, and includes the receiver 3, the network interface unit 106, the built-in recording medium 113, the removable recording medium 118, a recording device 121, and a recording device 122. The recording device 121 is connected, for example, via the network interface unit 106 and IEEE1394, and DTCP is utilized as a copyright protection system. The recording device 122 is connected, for example, via the network interface unit 106 and wired LAN or wireless LAN, and DTCP-IP (Digital Transmission Content Protection over Internet Protocol) is utilized as a copyright protection system. For example, when connection is performed in this way, content of “Number Limited Copy Allowed” received from broadcast wave is required to have total number of within 10 in the built-in recording medium 113, the removable recording medium 118, the recording device 121 and the recording device 122.

In this case, for example, there are 4 contents in a copy allowed state in the built-in recording medium 113, 2 contents in a copy allowed state in the removable recording medium 118, 1 content in the recording device 121, and 1 content in the recording device 122. In receiving and recording broadcast wave, recording to the built-in recording medium 113, the removable recording medium 118, the recording device 121 and the recording device 122 may be performed at the same time so as to be the above number, or recording may be performed only to the built-in recording medium 113, and after that copy may be performed to the removable recording medium 118, the recording device 121 and the recording device 122.

FIG. 19 is a drawing for understanding a typical sink of content accumulated with “Number Limited Copy Allowed”, and copy control thereof explained above, where an output source is, for example, the built-in recording medium 113 of the received record playing-back unit 10; analogue picture output (a composite picture output terminal, an S terminal, a D terminal or the like) in the outputting unit 116 uses CGMS-A (Copy Generation Management System-Analog) and Macrovision, as copy control; control of CGMS-A is set “only One Generation Copy Allowed”; and control of Macrovision inherits a value of ASP (Analog Protection System). Digital audio output (an optical audio output terminal or the like) uses SCMS (Serial Copy Management System) as copy control, and control thereof is set “only One Generation Copy Allowed”. In addition, the high speed digital interface (an IEEE1394 terminal or the like) in the network interface unit 106 uses DTCP (Digital Transmission Content Protection) as copy control, and control thereof is set “No More Copies” in playback, and is set “Move” in copying. In the removable recording medium 118, copy control of “Re-Copy Prohibited” at the recording destiny is performed.

In this way, because a plurality of recordings of the same program are possible in a plurality of recording media or recording devices, in receiving and recording broadcast wave, by performing suitable copy control in response to different sink, there is effect to attain content protection while attaining benefit of a user.

It should be noted that, explanation was given above that the above recording devices 121 and 122 are connected via IEEE1394 or L, respectively, however, it is not necessarily limited to IEEE1394 or LAN, and they may be connected by other connection methods.

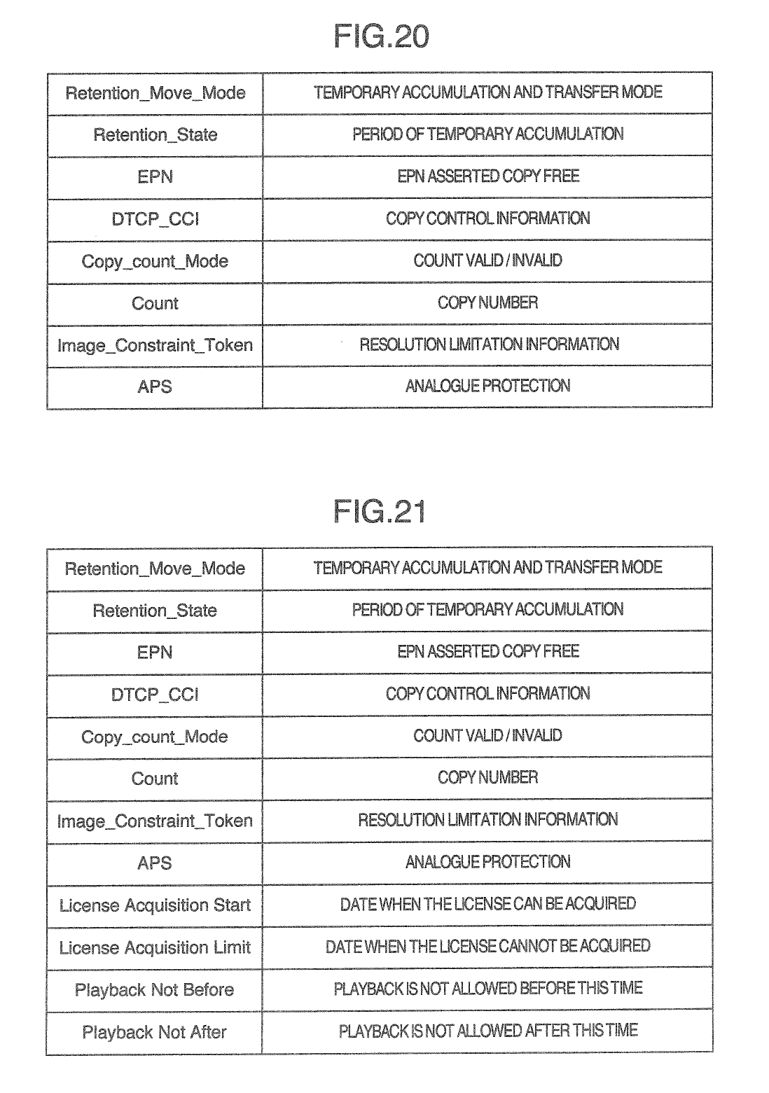

As described above, when content managed as “Number Limited Copy Allowed” is moved to a recording medium digitally connected, while maintaining copy number managed, it is necessary that total copy number should not be altered before and after the move, and explanation will be given on one example of a method thereof. When a TS packet is transmitted by DTCP-IP, DTCP_descriptor including copy control information of the content is set (added, added) in PMT, however, FIG. 20 is a drawing showing one example of a DTCP_descriptor thereof. The DTCP_descriptor includes retention_move_mode showing whether temporary accumulation or a transfer mode of a digital stream is specified or not, retention_state showing a period of temporary accumulation, DTCP_CCI (DTCP_Copy Control Information) showing whether copy of the digital stream of the MPEG2-TS system is allowed or not, EPN showing, when DTCP_CCI shows Copy Free, whether Copy Free thereof is EPN Asserted Copy Free or not, count showing number of allowed copy, Copy_count_Mode showing whether count information is valid or not, Image_Constraint_Token showing whether resolution limitation is posed or not, in playing-back and outputting the digital stream of the MPEG2-TS system, and APS (Analogue Protection System) showing whether protection in analogue output is performed or not, in analogue transforming and outputting the digital stream of the MPEG2-TS system. As described above, transmission of DTCP_descriptor is performed by setting (adding, adding) DTCP_descriptor in PMT, and storing it in the TS packet, however, in the case of transmitting the content other than MPEG2_TS, for example, MPEG2_PS and the like, copy control information of the above-described content data may be stored in a packet to be added as a packet separated from transmission content defined in DTCP_IP standard. Of course, also in transmitting MPEG2_TS, copy control information of the content data may be stored in a packet separated from the transmission content.

By performing suitable copy control by utilizing information of such Copy_count_Mode and Count, at a content transmission side and a receiving side, the relevant content can be moved while maintaining copy number managed, in recording the content managed as “Number Limited Copy Allowed” to a recording medium digitally connected by wired/wireless LAN or the like, and thus there is effect to attain content protection while attaining benefit of a user.

That is, by utilizing information on Copy_count_Mode and Count with extended DTCP-IP standards, the relevant content can be moved while maintaining copy number managed, in recording the content managed as “Number Limited Copy Allowed” to a recording medium digitally connected by wired/wireless LAN or the like.

In addition, when the content with “Number Limited Copy Allowed” received are outputted (broadcast live output) via wired/wireless LAN as they are, without accumulating them, by utilizing information on Copy_count_Mode and Count with extended DTCP-IP standards, it is possible to output them as “One Generation Copy Allowed” to a plurality of devices (provided that in a range not to exceed copy number limited in the content with “copy Number Limited Copy Allowed”) connected with LAN. It should be noted that, when number of devices to be connected is limited by DTCP-IP standards, the number should obey this standard.

Alternatively, it is possible to output as “Number Limited Copy Allowed”, by limiting connected user (number) of devices to be connected with LAN to one. Which one of the outputs is selected, it may be in accordance with the standards, for example, if it is specified by standards.

In this way, by utilizing information on Copy_count_Mode and Count, at a content transmission side and a receiving side, in broadcast live outputting content with “Number Limited Copy Allowed” and recording them in a recording medium digitally connected with wired/wireless LAN or the like, it is possible to output them as “One Generation Copy Allowed” to a plurality of devices (provided that in a range not to exceed copy number limited in the content with “copy Number Limited Copy Allowed”) connected with LAN, or to output them as “Number Limited Copy Allowed”, by limiting connected user (number) of devices to be connected with LAN to one, and thus there is effect to attain content protection while attaining benefit of a user.

Further, in the case of broadcast live outputting content with “Number Limited Copy Allowed” to a device to be connected with LAN, while recording it with “Number Limited Copy Allowed”, to a recording medium built-in in a receiving apparatus, by utilizing information on Copy_count_Mode and Count with extended DTCP-IP standards, it is possible to output it as “One Generation Copy Allowed”. In the case of broadcast live outputting content with “Number Limited Copy Allowed” to a device to be connected with LAN, without recording it to the recording medium built-in in the receiver, it is possible to output as “Number Limited Copy Allowed”.

In the case where content with “Number Limited Copy Allowed” was recorded with “One Generation Copy Allowed” in the recording medium built-in in the receiving apparatus, and in the case of broadcast live outputting them to a device to be connected with LAN, it is possible to output as “Number Limited Copy Allowed”. For example, if it is specified by standards, it may be in accordance with the standards.

In this way, by utilizing information on Copy_count_Mode and Count at a content transmission side and a receiving side, it is possible to broadcast live output content with “Number Limited Copy Allowed”, and record them to a recording medium digitally connected by wired/wireless LAN or the like, corresponding to a recorded state in the recording medium built-in in the receiving apparatus, and thus there is effect to attain content protection while attaining benefit of a user.

In addition, when the content with “Number Limited Copy Allowed” received are broadcast live outputted via wired/wireless LAN or the like, as they are, without accumulating them, by utilizing information on Copy_count_Mode and Count with extended DTCP-IP standards, it is also possible to connect in multiple connected user (number) of devices to be connected with LAN, and output by dividing copy number, however, sum (total) of copy number is limited to 10.

In this way, by utilizing information on Copy_count_Mode and Count, at a content transmission side and a receiving side, in broadcast live outputting content with “Number Limited Copy Allowed” received, and recording them to a recording medium digitally connected by wired/wireless LAN or the like, it is possible to connect in multiple connected user (number) of devices to be connected with LAN, and output it to each of the devices, by dividing copy number, and thus there is effect to attain content protection while attaining benefit of a user.

In addition, it is possible to output (move) the content with “Number Limited Copy Allowed” accumulated in a recording medium built-in in a receiving apparatus, as “Number Limited Copy Allowed”, by limiting connected user (number) of devices to be connected with LAN to one, by utilizing information on Copy_count_Mode and Count with extended DTCP-IP standards.

In this way, by utilizing information on Copy_count_Mode and Count, at a content transmission side and a receiving side, it is possible to output (move) the content accumulated as “Number Limited Copy Allowed”, as “Number Limited Copy Allowed”, by limiting connected user (number) of devices to be connected with LAN to one, and thus there is effect to attain content protection while attaining benefit of a user.

It should be noted that, explanation was given above on Count showing number of copies allowed, and Copy_count_Mode showing whether Count information is valid or not, however, it can be handled without any problem, only by “Count” showing number of copies allowed, without using Copy_count_Mode.

FIG. 21 is a drawing showing other example of DTCP_descriptor. In FIG. 21, because retention_move_mode, retention_state, DTCP_CCI (DTCP_Copy Control Information), EPN, Count, Copy_count_Mode, Image_Constraint_Token, and APS (Analogue Protection System) have the same description content as explained in FIG. 20, explanation will be omitted here, and explanation will be given below on License Acquisition Start, License Acquisition Limit, Playback Not Before, and Playback Not After.

These information are inputted from an exterior server or the like to the network interface unit 106, for example, via a line (an IEEE1394 cable or an LAN cable or a wireless LAN or the like), and used in receiving a encrypted download content accumulated in the built-in recording medium 113, or digital broadcasting signals transmitted from the transmitter 1 via a broadcast transmission network such as a satellite, terrestrial wave, a cable or the like at the tuner decoding unit 101, and recording metadata (data describing information on content) accumulated in the built-in recording medium 113, and a media file (a main body of content) and the like in a recording medium digitally connected by wired/wireless LAN or the like.

This download content include sales forms of, for example, a single item rental, a precedence single item rental, a pack rental, a single item cell, a precedence single item cell, a pack cell, or the like.

The single item rental is a sales form where downloading of the single item content is performed to a receiving terminal, and after acquiring a download playback license necessary to view the content from an exterior server, playback of the content becomes possible during a viewable period.

The precedence single item rental is a sales form of single item rental goods where content is sold in advance of the viewable period, and only download delivery of metadata and a media file is performed in advance. Release (premiered) date is set after completion of the content sales, and viewing becomes possible by acquiring the download playback license necessary to view the content hereafter, from an external server.

The pack rental is a form for selling a plurality of content in assembly (in a packed state), and the same viewable period is set for all the content in the pack. The single item cell is a sales form where download sales of content is performed to a receiving terminal, so as to make playback possible without limitation of a viewing period. There are two kinds of sales: sales accompanying with and not accompanying with export (this means to copy content to an exterior device with copyright protected, an exterior apparatus connected by a network with copyright protected, and in particular, means copying function of content, based on utilization condition) license to a medium is not allowed. The export license is acquired, for example, from an external server, when export is performed. The precedence single item cell is a sales form of single item cell goods where content is sold in advance of the viewable period, and only download delivery of metadata and a media file is performed in advance. Release (premiered) date is set after completion of the content sales, and viewing becomes possible by acquiring the download playback license necessary to view the content hereafter, from an external server. The pack cell is a sales form for selling a plurality of single item cell goods in assembly (in a packed state).

License Acquisition Start shows a date when the license can be acquired, for example, a date when the download playback license in the precedence single item rental or the precedence single item cell can be acquired. License Acquisition Limit shows a date when the license cannot be acquired, for example, a date when the license cannot be acquired, for example, a date when the download playback license or export license cannot be acquired. Playback Not Before shows that playback is not allowed before that date (time), for example, it is set in the case of content which cannot be viewed just after acquiring the download playback license in content of a rental form. Playback Not After shows that playback is not allowed after that date (time), for example, date (time) from becoming viewable and listenable till becoming not viewable, after acquiring the download playback license, in content of a rental form, that is, a rental period is set.

In this way, by utilizing information on License Acquisition Start, License Acquisition Limit, Playback Not Before, and Playback Not After, at a content transmitting side and a receiving side, it becomes possible to manage information on a license acquiring period, and a viewable period, in outputting content (the metadata and the media file) downloaded at the content transmitting side, and recording them to a recording medium digitally connected by wired/wireless LAN or the like, and thus there is effect to attain content protection while attaining benefit of a user.

In addition, when expiration of information on License Acquisition Limit or Playback Not After, that is, expiration of the license acquisition period, or expiration of the viewable period is ascertained in advance, it may be set not to output from the content transmitting side to the receiving side, or it may be controlled not to record at the receiving side, although it is outputted from the content transmitting side to the receiving side. Further, when License Acquisition Limit or Playback Not After is not expired, and when the content (the metadata and the media file) downloaded from the content transmitting side to the receiving side are transmitted and received, and recorded in a recording medium of the receiving side, management of the license acquisition period and viewable period is performed, based on information on License Acquisition Limit or Playback Not After received at the receiving side, and when expirations of either or both generates, the downloaded content (the metadata and the media file) recorded in the recording medium may be deleted at the receiving side.

By this way, there is effect to attain content protection while attaining further benefit of a user.

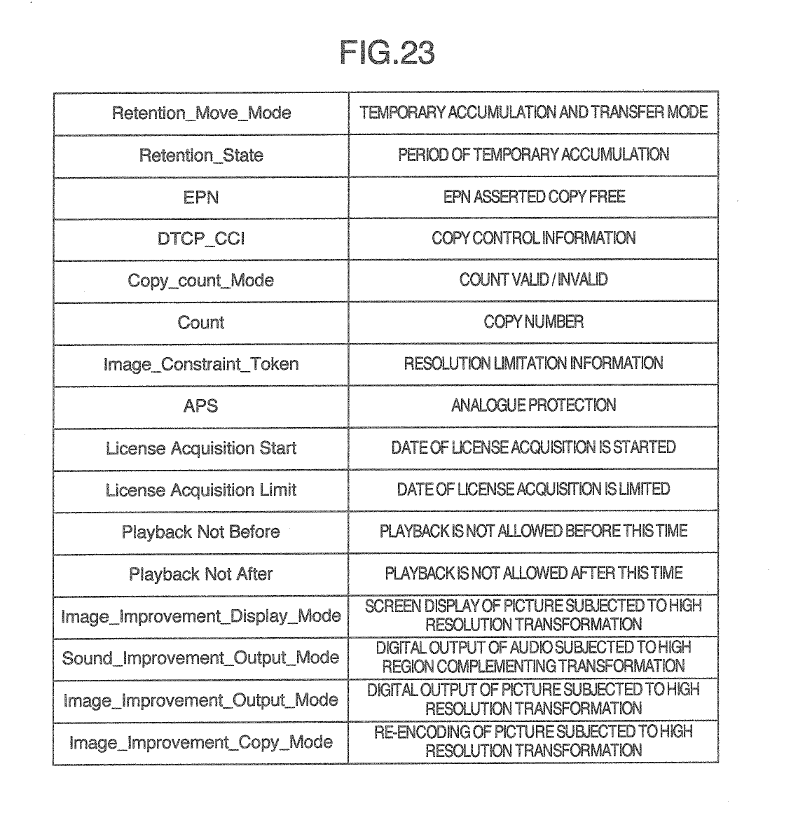

FIG. 23 is a drawing showing other example of DTCP_descriptor. In FIG. 23, because retention_move_mode, retention_state, DTCP_CCI (DTCP_Copy Control Information), EPN, Count, Copy_count_Mode, Image_Constraint_Token, APS (Analogue Protection System), License Acquisition Start, License Acquisition Limit, Playback Not Before and Playback Not After have the same description content as explained in FIG. 21, explanation will be omitted here, and explanation will be given below on Image_Improvement_Display_Mode, Sound_Improvement_Output_Mode, Image_Improvement_Output_Mode, and Image_Improvement_Copy_Mode.

Image_Improvement_Display_Mode is information showing whether display in a screen of picture subjected to high resolution transformation using super-resolution technology is allowed or not.

Sound_Improvement_Output_Mode is information showing whether digital output of audio subjected to high region complementing transformation using high region complementing technology is allowed or not.

Image_Improvement_putput_Mode is information showing whether digital output of picture subjected to high resolution transformation using super-resolution technology is allowed or not.

Image_Improvement_Copy_Mode is information showing whether re-encoding of picture subjected to high resolution transformation using super-resolution technology is allowed or not.

It should be noted that, high resolution transformation in the above explanation means the transformation for improving to higher resolution than resolution of picture of original content transmitted from a broadcasting station, as well as high region complementing transformation in the above explanation means the transformation for improving sound region in a higher frequency direction than sound region of audio of original content transmitted from a broadcasting station.

In addition, although not described in FIG. 23, information showing whether re-encoding of audio subjected to high region complementing transformation using high region complementing technology is allowed or not may be set further.

Still more, although not described in FIG. 23, information showing whether analog outputting of audio subjected to high region complementing transformation using high region complementing technology is allowed or not may be set further.

In addition, in explanation of FIG. 23, Image_Improvement_Display_Mode, Sound_Improvement_Output_Mode, Image_Improvement_Output_Mode, and Image_Improvement_Copy_Mode showed content showing whether screen display, digital output, analogue output and re-encoding after subjected to high resolution transformation or high region complementing transformation are possible or not, however, it is also possible to set information on content showing specifically limitation value (for example, equal to or lower than 1920×1080) of resolution degree transformable in the higher resolution transformation, and limitation value (for example, equal to or lower than 20 kPa) of higher region frequency in the high region complementing transformation.

In this way, by utilizing information showing whether screen display, digital output, analogue output and re-encoding after subjected to high resolution transformation or high region complementing transformation are possible or not, limitation value of resolution degree transformable in the higher resolution transformation, and limitation value of higher region frequency in the high region complementing transformation, at a transmitting side and a receiving side, at a receiving side which is connected user of a device to be connected with LAN, content accumulated in a recording medium, or content received from broadcast radio wave becomes possible to be performed receiving processing, based on the content set by the content transmitting side, and thus in displaying, recording and outputting content in the receiving apparatus, enhancement of usability can be attained, while performing display control, recoding limitation, output limitation and copy control, in consideration of intention of content providers or copyright owners, and thus there is effect to attain content protection while attaining benefit of a user.

It should be noted that, explanation was given above on Count showing number of copies allowed, and Copy_count_Mode showing whether Count information is valid or not, however, it can be responded without any problem, only by “Count” showing number of copies allowed, without using Copy_count_Mode.

In the case where a recording medium is a removable recording medium, there is other limitation in addition to FIG. 9. As for digital recording of program content to the removable recording medium, in digital recording of TV and data services, or digital recording of audio services, when digital_recording_control_data of the digital copy control descriptor is “10”, and the program content with “One Generation Copy Allowed” is received and recorded, three or more copies are not allowed even when the content received is one generation (for example, in receiving and recording broadcasting, recording to three or more recording media at the same time should not be allowed). This value (three or more is exemplified) may be, for example, in accordance with standards. In addition, a plurality of copies of one generation copy with the same recording format should not be allowed. However, digital recording to an area to which a user cannot access, for aiming at back up, is excluded. In addition, the recording limitation to the digital recording medium should be imposed by each receiving unit of broadcasting, and when a plurality of receiving units of broadcasting are present, the above limitation should be imposed by each receiving unit of one broadcasting. When a receiver mounts a recording format not corresponding to digital recording_control_mode, and a content protection system in recoding, as for program content with copy_control_type of the digital copy control descriptor of “01”, and digital_recording_control_data of “10”, content with digital_recording_control_mode of the content use descriptor of “1” is digitally recorded by handling as “One Generation Copy Allowed” (digital_recording_control_mode=“0”).

When a recording format corresponding to digital_recording_control_mode, and a content protection system in recoding are mounted, content with copy_control_type of the digital copy control descriptor of “01”, digital_recording_control_data of “10”, and digital_recording_control_mode of the content use descriptor of “1” can be recorded as “Number Limited Copy Allowed”. However, it should not be recorded to a removable recording medium, for example, at the same time as accumulation to a recording medium built-in in a receiving apparatus.

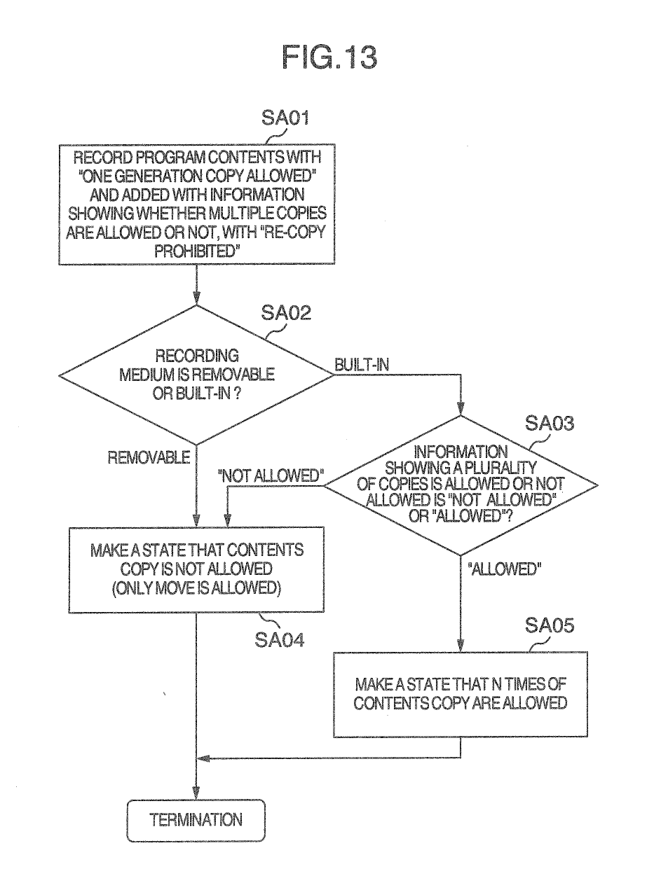

FIG. 13 is a flow chart showing an example of creation procedure of copy information and copy number of management information in recording program content with “One Generation Copy Allowed” by the receiver 3.

The content management information creation unit 119 inputs “01” to copy information of management information as “further copy not allowed”, that is, Re-Copy Prohibited (No More Copies), when it recognizes to be program content with “One Generation Copy Allowed” (Copy One Generation), and added with information showing whether multiple copies are allowed or not, from copy generation control information and information showing whether multiple copies are allowed or not, which come from the separation and extraction unit 103 (SA01).

Whether a recording medium for recording program content is built-in or removable is noticed, for example, from a control unit 114 to the content management information creation unit 119 (SA02).

In the case of “removable”, a state is made that copy of program content is not allowed but move (transfer) is allowed, for example, by inputting “0” to copy number of management information (SA04). It should be noted that, relation with an operation of “three or more copies not allowed” explained above is in difference that the above is copy control, for example, when receiving and recording broadcasting (when generating one generation copy), while explanation of FIG. 31 is copy control after recording in a recording medium (after generating one generation copy).

In the case of built-in, the content management information creation unit 119 judges whether information showing a plurality of copies is allowed or not, is “allowed” or “not allowed” (SA03).

In the case of “not allowed”, a state is made that copy of program content is not allowed but move (transfer) is allowed, for example, for example, by inputting “0” to copy number of management information (SA04). It is naturally possible to delete or the like.

In the case of “allowed”, a state is made that N times of copies of program content are allowed by inputting “N” to copy number of management information (SA05).

By this way, it becomes possible to copy multiple numbers of program content with “one generation copy of already recorded allowed” (Copy One Generation) without time limitation, and thus there is effect to enhance usability. Further, by judging whether a plurality of copies are allowed or not, based on whether a recording medium is built-in or removable, in the case of “built-in”, illegal manipulation can be avoided by managing program content by coding local encryption, and still more by coding an encryption also for key information, copy information, copy number among management information, as explained above. On the other hand, in the case of “removable”, many management methods are considered, and because not manageable one is also present, as in the case of “built-in”, as explained above, it is considered the case not avoidable of illegal manipulation, as well. From this reason, there is effect to attain content protection while attaining benefit of a user.

### <Copy Processing Relating to Copy Control Information>

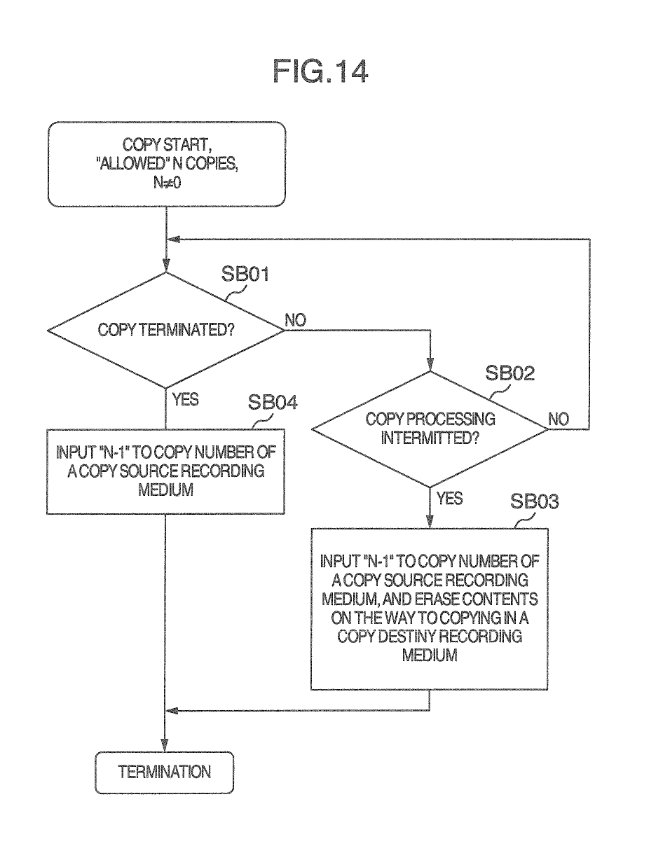

FIG. 14 is a flow chart showing an example of copying procedure of program content by the receiver 3.

In copying program content with copy information of management information of “01” (No More Copies), and copy number of “N” (N≠0), whether that the copy processing is completed or not is monitored (SB01).

In the case of “completed”, a state that N−1 copies of program content are allowed, a state that re-copy is prohibited and a state that copy of program content is not allowed but move (transfer) thereof is allowed are made by inputting “N−1” (N≠0) to copy number of management information of a copy source recording medium, “01” (No More Copies) to copy information of management information of a copy destiny recording medium, and “0” to copy number of management information, respectively (SB04).

In the case of “not completed”, whether copy processing is intermitted or not is monitored (SB02).

In the case of “not intermitted”, whether copy processing is completed or not is monitored (SB01).

In the case of “intermitted”, a state that N−1 copies of program content are allowed is made, by inputting “N−1” (N≠0) to copy number of management information of a copy source recording medium, and in the case that the copy source recording medium is recordable multiple times, program content on the way to copying are erased (SB03). However, because in the case of a recording medium being allowable to copy only once, it cannot be erased, erasing processing is not performed.

By this way, there is effect to surely perform copy generation management of program content of copy destiny. In addition, because unnecessary program content does not remain in the copy destiny, even when interruption of copy processing generates for some reason or other, there is effect to save a process of erasing afterwards and to attain usability. It should be noted that, the above erasing may be performed by physically erasing data on a recording medium, or by making playback impossible, although data on the recording medium is present, by erasing management information (indirectly erasing).

### <Move (Transfer) Processing Relating to Copy Control Information>

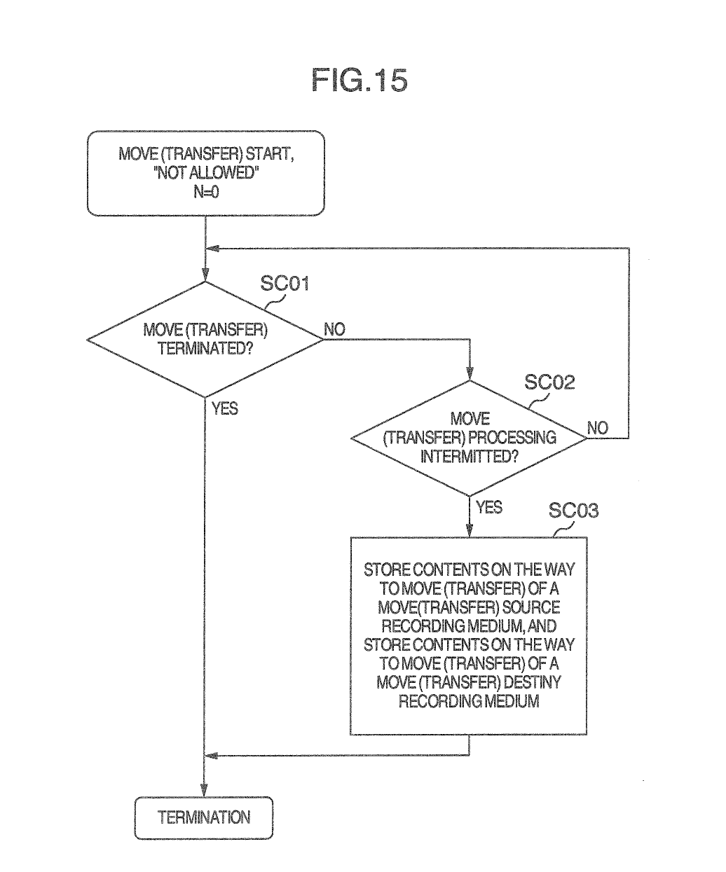

FIG. 15 is a flow chart showing an example of moving (transferring) procedure of program content by a receiver relevant to the Example.

In moving (transferring) program content with copy information of management information of “01” (No More Copies), and copy number of “0”, whether that the move processing is completed or not is monitored (SC01).

In the case of “completed”, program content of a move destiny recording medium and management information relating to the program content are erased, and a state that re-copy is prohibited, and a state that copy of program content is not allowed but move is allowed are made by inputting “01” (No More Copies) to copy information of management information of the move destiny recording medium, and “0” to copy number of management information, respectively.

In the case of “not completed”, whether move processing is intermitted or not is monitored (SC02).

In the case of “not intermitted”, whether move processing is completed or not is monitored (SC01).

In the case of “intermitted”, program content of a part of move source recording medium on the way to move and not yet transferred to a move destiny recording medium, and management information relating to the program content are stored to make impossible playback of the program content already transferred to the move destiny recording medium. By storing program content of the move destiny recording medium on the way to move, a state that re-copy is prohibited and a state that copy of program content is not allowed but move is allowed are made by inputting “01” (No More Copies) to copy information of management information, and “0” to copy number of management information, respectively (SC03)

By this way, there is effect to surely perform copy generation management of program content of move destiny. In addition, because program content are stored in each of the recording media of the move source and the move destiny, even when interruption of move processing generates for some reason or other, and thus it does not occur that program content cannot be viewed, caused by interruption, there is effect to attain usability. It should be noted that, the above erasing may be performed by physically erasing data on a recording medium, or by making playback impossible, although data on the recording medium is present, by erasing management information (indirectly erasing).

It should be noted that, in the above explanation, a recording medium of a copy destiny or a move destiny is a manageable recording medium as “Re-Copy Prohibited” (No More Copies). In the case of “non manageable”, copy or move processing is prohibited.

In addition, explanation was given above on the case of program content broadcasted from a broadcasting station, however, it is also applicable, for example, to program content transmitted from, for example, program content providing business operators other than the broadcasting station.

In addition, a removable recording medium means a recording medium having an independent form detachable from a receiver, and reproducible in a device having other playback function, as well.

In addition, move “transfer” means to perform transfer of program content by copying the program content with “Re-Copy Prohibited (No More Copies)” recorded in a recording medium, to other recording medium, and then making them to a non reproducible state. In this case, “to make a playback impossible” means to make a playback impossible by erasing the program content themselves, erasing encryption key, erasing management information or the like. It is preferable that, on the way to move processing, the program content with a length of over 1 (one) minute are not present in a reproducible state in both a move source and a move destiny at the same time.

In the above explanation, judgment that a plurality of copies are allowed for program content with “One Generation Copy Allowed (Copy One Generation)” and with “information showing whether a plurality of copies are allowed or not” of “allowed” was performed, based on whether the recording medium is built-in or removable, however, judgment that a plurality of copies are allowed may be performed, by a recording medium which is capable of managing a plurality of copies, and by a recording medium which is not capable of managing a plurality of copies. In this case, the recording medium which is capable of managing a plurality of copies means, for example, a recording medium which is capable of managing not to allow illegal manipulation on information on copy information 507, copy number 508, key information 506 (in addition, file number 503, date 504, prologue address of a data region and recording size 505 or the like may be included) among management information showing details of program content explained in the above FIG. 12.

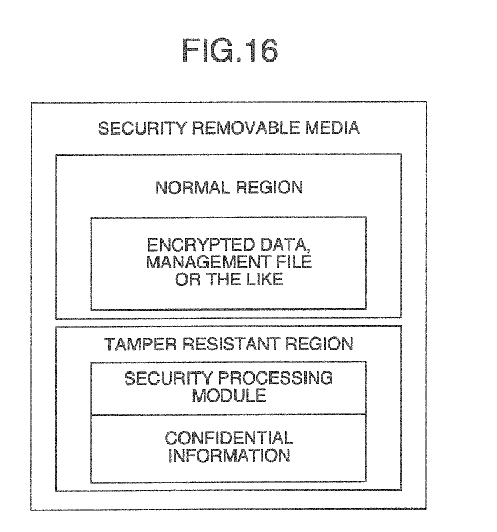

FIG. 16 shows a configuration example of recording media (security removable media) which are capable of managing multiple numbers of copies (which may also be called copy number control, number controlled copy) in this way. It is a configuration having together a normal region to which a user can access, and a tamper resistant region to which a user cannot access, in one recording medium. Confidential information stored in the tamper resistant region, when authentication is confirmed by authentication processing with a device which can handle this recording medium, is designed to be accessible so that confidential information can be managed. Illegal manipulation is not performed by managing the above copy information 507, copy number 508, and key information 506, by storing in this tamper resistant region.

On the other hand, the recording medium which is not capable of managing a plurality of copies means, for example, a recording medium which is not capable of managing not to allow illegal manipulation on information on copy information 507, copy number 508, and key information 506 (in addition, file number 503, date 504, and prologue address of a data region and recording size 505 or the like may be included) among management information showing details of program content.

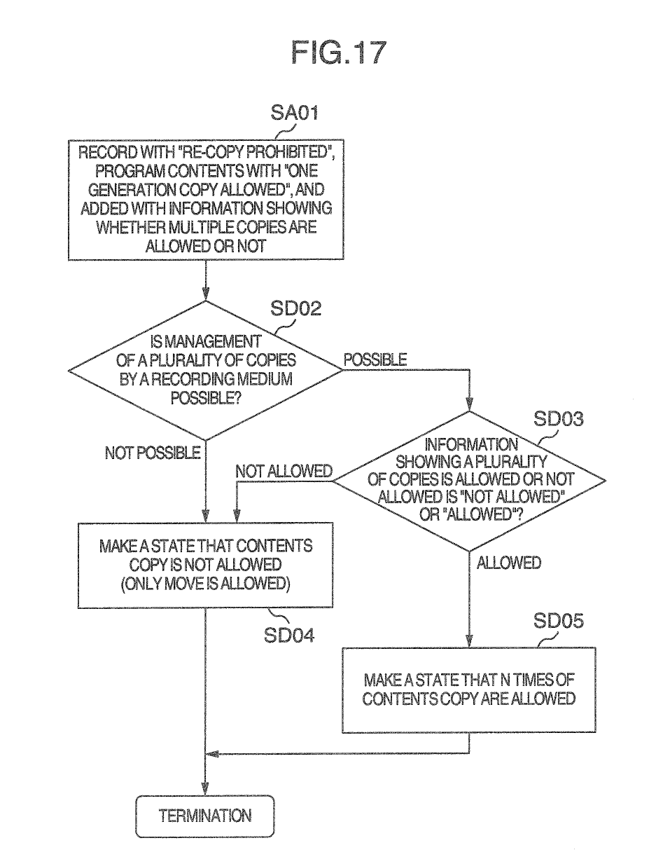

FIG. 17 shows a flow chart showing an example of creation procedure of copy information and copy number of management information in recording program content with “One Generation Copy Allowed” by a receiver, in consideration of the recording medium which is capable and not capable of managing a plurality of copies. Difference from FIG. 13 is SD02. It should be noted that, a combination with FIG. 13 is also allowed, or it may be set so that SD02 is performed, for example, in the case of being “removable” in SA02.

Whether a recording medium for recording program content is a recording medium which is capable of managing a plurality of copies, or a recording medium which is not capable of managing a plurality of copies is judged, for example, by the control unit 114, and noticed to the content management information creation unit 119 (SD02).

In the case of the recording medium which is not capable of managing a plurality of copies, a state is made that copy of program content is not allowed but move (transfer) is allowed, by inputting, for example, “0” to copy number of management information (SD04).

In the case of the recording medium which is capable of managing a plurality of copies, the content management information creation unit 119 judges whether information showing a plurality of copies is allowed or not allowed is “allowed” or “not allowed” (SD03), and in the case of “not allowed”, a state is made that copy of program content is not allowed but move (transfer) is allowed, by inputting, for example, “0” to copy number of management information (SD04). In the case of “allowed”, a state is made that N pieces of copy of program content are allowed, by inputting “N” to copy number of management information (SD05).

By this way, it becomes possible to copy multiple numbers of program content with “One Generation Copy of already recorded Allowed” (Copy One Generation) without time limitation, and thus there is effect to enhance usability. In addition, by judging whether a plurality of copies are allowed or not allowed, depending on whether a recording medium is one which is capable of managing a plurality of copies, or one which is not capable of managing a plurality of copies, allowance of a plurality of copies to the recording medium which is not capable of managing a plurality of copies can be avoided, which has effect of surely protecting program content.

Explanation was given above that in the case where digital copy control information is “One Generation Copy Allowed”, when “digital_recording_control_mode” is “1” and “0”, it is judged to be an object of “Number Limited Copy Allowed”, and not to be an object of “Number Limited Copy Allowed”, respectively, however, judgment of “0” and “1” may be set reversely, for example, in suiting the convenience of a system of a broadcasting station.

That is, in the case where digital copy control information is “One Generation Copy Allowed”, and when “digital_recording_control_mode” is “1” and “0”, it is judged to be an object of “Number Limited Copy Allowed”, and not to be an object of “Number Limited Copy Allowed”, respectively. Similarly, it may be altered to different setting in response to situation, as for meaning of value shown by other descriptors.

In addition, it is desirable that meaning of value shown by each descriptor such as value of “digital_recording_control_mode” is determined unambiguously by standardization.

In addition, the name of the content use descriptor or digital copy control descriptor (“digital_recording_control_mode” or “digital_recording_control_data” or the like) may not necessarily be the name in Examples, and other names may be adopted.

It should be further understood by those skilled in the art that although the foregoing description has been made on embodiments of the invention, the invention is not limited thereto and various changes and modifications may be made without departing from the spirit of the invention and the scope of the appended claims.

1. An output control method in a receiver for receiving digital content and output control information for controlling output of said digital content, and for outputting the digital content according to the output control information,
wherein when the output control information received shows that picture subjected to high resolution transformation using super-resolution technology is not allowed to be displayed on a screen, it is outputted in resolution equal to or lower than resolution of picture of the digital content received.

2. The output control method according to claim 1,
wherein, in re-encoding the digital content received, when the output control information received shows that picture subjected to high resolution transformation using super-resolution technology is not allowed to be re-encoded, it is re-encoded in resolution equal to or lower than resolution of picture of the digital content received.

3. The output control method according to claim 1,
wherein, in outputting the digital content received, when the output control information received shows that audio subjected to high region complementation transformation using high region complementation technology is not allowed to be outputted, the digital content received is outputted in high frequency equal to or lower than high frequency of audio of the digital content received.

4. A receiver for receiving digital content and output control information for controlling output of said digital content, and for outputting the digital content according to the output control information,
wherein when the output control information received shows that picture subjected to high resolution transformation using super-resolution technology is not allowed to be displayed on a screen, the digital content received is outputted in resolution equal to or lower than resolution of picture of the digital content received.

5. The receiver according to claim 4,
wherein, in re-encoding the digital content received, when the output control information received shows that picture subjected to high resolution transformation using super-resolution technology is not allowed to be re-encoded, the digital content received is re-encoded in resolution equal to or lower than resolution of picture of the digital content received.

6. A receiver for receiving digital content and output control information for controlling output of said digital content, and for outputting the digital content according to the output control information,
wherein, when the output control information received shows that audio subjected to high region complementation transformation using high region complementation technology is not allowed to be digital outputted, the digital content received is outputted in high frequency equal to or lower than high frequency of audio of the digital content received.
